(19) United States
(12) Patent Application Publication
(10) Pub. No.: US 2009/0144209 A1
(43) Pub. Date: Jun. 4, 2009

(54) SEQUENCE PREDICTION SYSTEM

(75) Inventor: Tomoya Miyakawa, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 11/571,822

(22) PCT Filed: Jul. 7, 2005
(86) PCT No.: PCT/JP05/12542

§ 371 Date: Nov. 12, 2008

(30) Foreign Application Priority Data
Jul. 7, 2004 (JP) 2004-201116

(51) Int. Cl. G06F 15/18; G06F 7/06; G06F 17/30

(52) U.S. Cl. 706/12; 707/3; 707/102; 707/E17.044; 707/E17.014

(57) ABSTRACT

The system includes a storage device 126 as a database having biopolymer attributes which contain sequences of a biopolymer, and add values owned by the biopolymer having the sequences; a data control section 128 as a selection section selecting N data sets from the storage device 126;
a generation section 102 generating a different plurality of data subsets from the data sets; and a learning section 104 generating a hypothesis for each of the individual data subsets, applying the hypotheses respectively to second data sets composed of biopolymer sequences independent of the data sets, to thereby derive add values of the biopolymer sequences relevant to the second data sets.

### TECHNICAL FIELD

The present invention relates to a sequence prediction system, and in particular to a sequence prediction system and a sequence prediction database used for predicting sequence of peptide having a specific property. The present invention relates also to a sequence prediction support system supporting the sequence prediction. The present invention relates also to a sequence prediction program and a method therefor allowing the sequence prediction system to operate. The present invention relates still also to a sequence prediction support program and a method therefor allowing the sequence prediction support system to operate.

### BACKGROUND ART

Infection of virus such as hepatitis C virus (HCV) induces viral clearance reaction based on naturalimmunity, which is followed by induction of specific immune response and viral clearance reaction.

In the specific immune response, virus in body fluid is excluded with the aid of neutralizing antibody, and the virus in cells is excluded by cytotoxic T cell (CTL). For more details, the CTL specifically recognizes a virual antigen (CTL epitope) composed of 8 to 11 amino acids, presented by an HLA Class I molecule on the surface of infected cells, and injures the infected cells to thereby clear the virus. Identification of such virus-specific CTL epitope is, therefore, important in view of preparing a therapeutic vaccine against the virus.

Identification of the CTL epitope has been conducted by predicting an epitope using a database such as BIMAS, SYFPEITHI or the like, subjecting the epitope to an experiment for confirming whether the epitope actually binds with the HLA molecule according to the prediction or not, wherein the one showed actual bonding has been identified as the CTL epitope.

In the methods using a database such as BIMAS, SYFPEITHI and the like, the peptide once judged as bindable with the HLA molecule has, however, often failed in actual binding, so that it has been difficult to identify the CLT epitope as predicted.

Non-patent document 1 describes a method of more correctly identifying a peptide bindable with the HLA molecule, aiming at identifying the peptide bindable with the HLA molecule by less experiment.

[Non-patent document 1] Udaka, K., et al, ‘Empirical Evaluation of a Dynamic Experiment Design Method for Prediction of MHC Class I-Binging Peptides’, The Journal of Immunology, 169, p5744-5753, 2002

### DISCLOSURE OF THE INVENTION

As for peptide sequences arbitrarily selected by a computer, non-patent document 1 discloses that whether they have a predetermined property, for example a binding ability to the above-described HLA molecule, or not is judged, wherein whether the actually selected peptide sequences have the predetermined property or not was confirmed by experiments. Non-patent document 1 describes it was confirmed by experiments that the selected peptide sequence actually had the predetermined property to a high probability (p. 5749, right column, second paragraph).

The technique described in non-patent document 1 is, however, not directly applicable and insufficient for the purpose of quantitatively judging whether the predicted peptide sequence has a predetermined property necessary for functioning as a viral antigen, placing focus on a specific target, such as viral antigen, and selecting only sequences judged as having the property, without relying upon experiments.

On the other hand, accurate sequence prediction is also expected for DNA sequence prediction for transcription factor binding site, RNAi (RNA interference) sequence prediction, RNA aptamer sequence prediction and so forth, similarly to the peptide sequence.

The present invention was conceived after considering the above-described situation, and an object thereof is to provide a sequence prediction system and a sequence prediction database, a sequence prediction support system, a sequence prediction program and sequence prediction support program, and a method of sequence prediction and a method of supporting sequence prediction, capable of selecting only a biopolymer sequence having a predetermined property, without relying upon experiments.

Aimed at solving the above-described problems, there is provided a sequence prediction system according to the present invention comprising:

a database having biopolymer attributes which contain sequences of a biopolymer, and add values owned by the biopolymer having the sequences;

a selection section selecting N data sets from the database;

a generation section generating a different plurality of data subsets from the data sets;

a learning section generating a hypothesis for each of the individual data subsets, applying the hypotheses respectively to second data sets composed of biopolymer sequences independent of the data sets, to thereby derive add values of the biopolymer sequences relevant to the second data sets;

a question point extraction section finding variances of the add values for the individual biopolymer sequences in the second data sets, and extracting, as question points, biopolymer sequences having variances larger than a predetermined reference level;

a data control section accepting the add values corresponded to the question point, and accumulating the accepted add values in the database so as to correlate them with the biopolymer sequences relevant to the question point;

a sequence entry acceptance section accepting all sequences of a predetermined biopolymer;

a sequence candidate extraction section extracting biopolymer sequence candidates to be predicted, from all sequences accepted by the sequence entry acceptance section; and

an add value estimation section generating, after entry and acceptance of the sequences, a law based on all data sets of the database, and applying the law respectively to the biopolymer sequence candidates, to thereby estimate add values of the biopolymer sequence candidates.

According to this configuration, N data sets are fetched from the database by the selection section, and a plurality of different data subsets are generated from these N data sets by the generation section. The learning section carries out analysis independently for each of the data subsets to thereby generate certain hypotheses, and applies the hypotheses to the biopolymer sequences of the second data sets, to thereby derive add values. The number of generation of the second data set containing the biopolymer sequences and the derived add values is the same with the number of the data subsets. As a consequence, with respect to the same biopolymer sequence, add values are respectively derived based on the hypotheses from the individual data subsets. In the question point extraction section, variances are found for the plurality of add values derived corresponded to the same biopolymer sequence, and only biopolymer sequences having variances larger than a predetermined reference level are extracted as the question point. The data control section accepts the add values corresponded to the question point, and accumulates the accepted add values in the database so as to correlate them with the biopolymer sequences relevant to the question point, to thereby update contents of the database. On the other hand, the sequence entry acceptance section accepts all sequences of the predetermined biopolymer, and the sequence candidate extraction section extracts the biopolymer sequence candidates as objects for which the add values are predicted, from all sequences. The add value estimation section generates a law based on the data sets of thus-updated database, and applies the law respectively to the biopolymer sequence candidates, to thereby estimate add values with respect to the individual biopolymer sequences.

In this sequence prediction system, the learning section may be configured also so as to function as the add value estimation section, after entry and acceptance of the sequences.

In short, it is made possible on a single computer system to apply, in the process of updating the contents of the database, the hypotheses generated for each of the plurality of data subsets from by the generation section, to thereby derive the add values for the individual biopolymer sequences composing the arbitrarily-generated second data sets, and to apply, in the process of prediction of the add values, the law generated from the data sets contained in the already-updated database, to thereby calculate the add values as the estimated values for the individual biopolymer sequence candidates.

In this sequence prediction system, the sequence candidate extraction section may extract a biopolymer sequence by “p” monomer fetched units from the head of all sequences accepted by the sequence entry acceptance section, and then extract the succeeding biopolymer sequence candidates by “p” monomer fetched units at a time, at intervals of “q” monomer units, shifted towards the downstream side.

The sequence candidate extraction section may exclude, from the extracted biopolymer sequence candidates, any biopolymer sequences which satisfy a predetermined condition in no need of prediction, before being sent to the add value estimation section.

By virtue of this configuration, unnecessary sequences can be excluded from the biopolymer sequence candidates before prediction, and can thereby reduce unnecessary calculation for the prediction.

In the question point extraction section in this sequence prediction system, the biopolymer sequences having variances within a predetermined range away from the largest variance may be extracted as the question point, or the biopolymer sequences having variances larger than a predetermined value may be extracted as the question point.

According to this configuration, it is made possible to continue extraction of the question point, until the hypotheses derived from the learning section converge to a certain degree.

In these sequence prediction systems, it is allowable to further provide a sequence extraction section extracting the biopolymer sequence candidates having the add value which satisfy a predetermined condition, from the add values of the individual biopolymer sequence candidates estimated by the add value estimation section.

According to this configuration, the biopolymer sequences having the estimated add values which satisfy the predetermined condition can be extracted as the sequences to be predicted.

A sequence prediction system of the present invention includes:

a database having biopolymer attributes which contain sequences of a biopolymer, and add values owned by the biopolymer having the sequences;

a sequence entry acceptance section accepting all sequences of a predetermined biopolymer;

a sequence candidate extraction section extracting biopolymer sequence candidates to be predicted, from all sequences accepted by the sequence entry acceptance section; and

an add value estimation section generating, after acceptance of the sequences, a law based on all data sets of the database, and applying the law respectively to the biopolymer sequence candidates, to thereby estimate add values of the biopolymer sequence candidates.

According to this configuration, the sequence entry acceptance section accepts all sequences of a predetermined biopolymer, and the sequence candidate extraction section extracts, from all these sequences, the biopolymer sequence candidates for as an object which the add values are to be predicted. The add value estimation section generates a law from the data sets in the database, and applies the law respectively to the biopolymer sequence candidates to thereby estimate the add values for the individual biopolymer sequences.

The sequence prediction database according to the present invention contains the add values obtained by the above-described sequence prediction system, and the biopolymer sequences.

A sequence prediction support system according to the present invention includes:

a database having biopolymer attributes which contain sequences of a biopolymer, and add values owned by the biopolymer having the sequences;

a selection section selecting N data sets from the database;

a generation section generating a different plurality of data subsets from the data sets;

a learning section generating a hypothesis for each of the individual data subsets, applying the hypotheses respectively to second data sets composed of biopolymer sequences independent of the data sets, to thereby derive add values of the biopolymer sequences relevant to the second data sets;

a question point extraction section finding variances of the add values for the individual biopolymer sequences in the second data sets, and extracting, as a question point, biopolymer sequences having variances larger than a predetermined reference level; and

a data control section accepting the add values corresponded to the question point, and accumulating the accepted add values in the database so as to correlate them with the biopolymer sequences relevant to the question point.

According to this configuration, the selection section fetches N data sets from the database, and the generation section generates a plurality of different data subsets from N data sets. The learning section generates a certain hypothesis by independently analyzing each of the data subsets, and applies the hypothesis to the biopolymer sequence of the second data sets to thereby derive the add values. The number of generation of the second data set containing the biopolymer sequences and the derived add values is the same with the number of the data subsets. In other words, with respect to the same biopolymer sequence, the add values are respectively derived based on the hypotheses of the individual data subsets. The question point extraction section finds variances of a plurality of add values derived with respect to the same biopolymer sequence, and extracts the biopolymer sequences having variances larger than a predetermined reference level as the question point. The data control section accepts the add values corresponded to the question point, and accumulates them in the database as being correlated with the biopolymer sequences relevant to the question point, thereby the contents of the database is updated, and the database supporting the sequence prediction is thus constructed.

A sequence prediction program according to the present invention allows a computer to function as a sequence prediction system which comprises:

a database having biopolymer attributes which contain sequences of a biopolymer, and add values owned by the biopolymer having the sequences;

a selection section selecting N data sets from the database;

a generation section generating a different plurality of data subsets from the data sets;

a learning section generating a hypothesis for each of the individual data subsets, applying the hypotheses respectively to second data sets composed of biopolymer sequences independent of the data sets, to thereby derive add values of the biopolymer sequences relevant to the second data sets;

a question point extraction section finding variances of the add values for the individual biopolymer sequences in the second data sets, and extracting, as a question point, biopolymer sequences having variances larger than a predetermined reference level;

a data control section accepting the add values corresponded to the question point, and accumulating the accepted add values in the database so as to correlate them with the biopolymer sequences relevant to the question point;

a sequence entry acceptance section accepting all sequences of a predetermined biopolymer;

a sequence candidate extraction section extracting biopolymer sequence candidates to be predicted, from all sequences accepted by the sequence entry acceptance section; and

an add value estimation section generating, after acceptance of the sequences, a law based on all data sets of the database, and applying the law respectively to the biopolymer sequence candidates, to thereby estimate add values of the biopolymer sequence candidates.

According to this configuration, N data sets are fetched from the database by the selection section, and a plurality of different data subsets are generated from these N data sets by the generation section. The learning section carries out analysis independently for each of the data subsets to thereby generate certain hypotheses, and applies the hypotheses to the biopolymer sequences of the second data sets, to thereby derive add values. The number of generation of the second data set containing the biopolymer sequences and the derived add values is the same with the number of the data subsets. As a consequence, with respect to the same biopolymer sequence, add values are respectively derived based on the hypotheses ascribable to the individual data subsets. In the question point extraction section, variances are found for the plurality of add values derived corresponded to the same biopolymer sequence, and only biopolymer sequences having variances larger than a predetermined reference level are extracted as the question point. The data control section accepts the add values corresponded to the question point, and accumulates the accepted add values in the database so as to correlate them with the biopolymer sequences relevant to the question point, to thereby update contents of the database. On the other hand, the sequence entry acceptance section accepts all sequences of the predetermined biopolymer, and the sequence candidate extraction section extracts the biopolymer sequence candidates as an object for which the add values are predicted, from all sequences. The add value estimation section generates a law based on the data sets of thus-updated database, and applies the law respectively to the biopolymer sequence candidates, to thereby estimate add values with respect to the individual biopolymer sequences. In this way, a general-purpose computer device can function as a sequence prediction system.

A sequence prediction program according to the present invention allows a computer device to function as a sequence prediction system which includes:

a database having biopolymer attributes which contain sequences of a biopolymer, and add values owned by the biopolymer having the sequences;

a sequence entry acceptance section accepting all sequences of a predetermined biopolymer;

a sequence candidate extraction section extracting biopolymer sequence candidates to be predicted, from all sequences accepted by the sequence entry acceptance section; and

an add value estimation section generating, after acceptance of sequence entry, a law based on all data sets of the database, and applying the law respectively to the biopolymer sequence candidates, to thereby estimate add values of the biopolymer sequence candidates.

According to this configuration, the sequence entry acceptance section accepts all sequences of a predetermined biopolymer, and the sequence candidate extraction section extracts, from all sequences, the biopolymer sequence candidates as an object for which the add values are to be predicted. The add value estimation section generates a law based on all data sets of the database, and applies the law respectively to the biopolymer sequence candidates, to thereby estimate the add values for the individual biopolymer sequences candidates. In this way, a general-purpose computer device can function as a sequence prediction system.

A sequence prediction support program according to the present invention allows a computer device to function as a sequence prediction support system which includes:

a database having biopolymer attributes which contain sequences of a biopolymer, and add values owned by the biopolymer having the sequences;

a selection section selecting N data sets from the database;

a generation section generating a different plurality of data subsets from the data sets;

a learning section generating a hypothesis for each of the individual data subsets, applying the hypotheses respectively to second data sets composed of biopolymer sequences independent of the data sets, to thereby derive add values of the biopolymer sequences relevant to the second data sets;

a question point extraction section finding variances of the add values for the individual biopolymer sequences in the second data sets, and extracting, as question points, biopolymer sequences having variances larger than a predetermined reference level; and

a data control section accepting the add values corresponded to the question point, and accumulating the accepted add values in the database so as to correlate them with the biopolymer sequences relevant to the question point.

According to this configuration, the selection section fetches N data sets from the database, and the generation section generates a plurality of different data subsets from N data sets. The learning section generates a certain hypothesis by independently analyzing each of the data subsets, and applies the hypothesis to the biopolymer sequence of the second data sets to thereby derive the add values. The number of generation of the second data set containing the biopolymer sequences and the derived add values is the same with the number of the data subsets. In other words, with respect to the same biopolymer sequence, the add values are respectively derived based on the hypotheses of the individual data subsets. The question point extraction section finds variances of a plurality of add values derived with respect to the same biopolymer sequence, and extracts the biopolymer sequences having variances larger than a predetermined reference level as the question point. The data control section accepts the add values corresponded to the question point, and accumulates them in the database as being correlated with the biopolymer sequences relevant to the question point, thereby the contents of the database is updated, and the database supporting the sequence prediction is thus constructed. In this way, a general-purpose computer device can function as a sequence prediction support system.

A method of sequence prediction according to the present invention includes

a data supply step selecting N data sets from a database having sequences of a biopolymer and add values owned by the biopolymer having the sequences, generating a different plurality of data subsets from said data sets, and supplying them to a learning section;

a hypothesis derivation step generating, in said learning section, a hypothesis for each of the individual data subsets, applying said hypotheses respectively to second data sets composed of biopolymer sequences independent of said data sets, to thereby derive add values of said biopolymer sequences relevant to said second data sets;

a variance calculation step calculating variances of the add values of each of said biopolymer sequences in said second data sets;

a question point extraction step extracting, as a question point, biopolymer sequences having variances larger than a predetermined reference level among thus-calculated variances;

a data updating step accepting the add values corresponded to said question point, and accumulating thus-accepted add values in said database so as to correlate them with said biopolymer sequences relevant to said question point;

a sequence candidate extraction step accepting all sequences of a predetermined biopolymer, and extracting biopolymer sequence candidates to be predicted, from thus-accepted all sequences; and

an add value estimation step generating, after acceptance of entry of the sequences, a law based on all data sets of said database, and applying said law respectively to said biopolymer sequence candidates, to thereby estimate add values of said biopolymer sequence candidates.

A method of supporting sequence prediction according to the present invention includes a data supply step selecting N data sets from a database having biopolymer attributes which contain sequences of a biopolymer, and add values owned by the biopolymer having the sequences, generating a different plurality of data subsets from the data sets, and supplying them to a learning section;

a hypothesis derivation step generating, in the learning section, a hypothesis for each of the individual data subsets, applying the hypotheses respectively to the second data sets composed of biopolymer sequences independent of the data sets, to thereby derive add values of the biopolymer sequences relevant to the second data sets;

a variance calculation step calculating variances of the add values of each of the biopolymer sequences in the second data sets;

a question point extraction step extracting, as question points, biopolymer sequences having variances larger than a predetermined reference level among thus-calculated variances; and

a data updating step accepting the add values corresponded to the question point, and accumulating thus-accepted add values in the database so as to correlate them with the biopolymer sequences relevant to the question point.

The sequence prediction system, the sequence prediction support system, the sequence prediction program, the sequence prediction support program and the method of sequence prediction according to the present invention also include the aspects described below.

One aspect of the sequence prediction system includes a database having stored therein data containing peptide sequences each composed of a first predetermined number of amino acids, and a property providing an index of a predetermined biological activity of the peptide sequences; a plurality of learning sections deriving hypotheses for a third predetermined number of peptide sequences from the peptide sequences and the property, based on a second predetermined number of the data; a random re-sampling section fetching a fourth predetermined number of data from the database, and randomly supplying them to each of the learning sections by the second predetermined number of data at a time; a target sequence setting section setting a predetermined peptide sequence contained in the hypotheses derived by the individual learning sections; a target property extraction section extracting respectively, from the hypotheses derived by each of the learning sections, the property specified by thus-set predetermined peptide sequences; a variance evaluation section evaluating variances of the property extracted from each of the learning sections; a question point extraction section extracting a peptide sequence as an object to which a true data for the property of the hypothesis is requested, based on thus-evaluated variance; a data updating section accepting the requested true data, and correlating the extracted peptide sequence with the property based on the true data; a data control section accumulating a new data obtained by the data updating section as containing the peptide sequence and the property based on the true data, into the database; a sequence entry acceptance section accepting all amino acid sequences of a predetermined protein; a sequence candidate extraction section extracting peptide sequence candidates to be predicted, from all amino acid sequences accepted by the sequence entry acceptance section, and sending thus-extracted peptide sequence candidates to the learning sections; and a property estimation section estimating the property of the extracted peptide sequence candidates, based on the results obtained from each of the learning sections.

According to this configuration, the fourth predetermined number of data are randomly re-sampled from the database by the random re-sampling section by the second predetermined number, smaller than a predetermined fourth number, of data at a time, and are sent to the individual learning sections. In this re-sampling, data different for every learning section are sent. In each of the learning sections, the sent data is analyzed to thereby generate a certain hypothesis, that is, a data set relevant to a predetermined property found for a third predetermined number of peptide sequences is derived, based on the peptide sequence composed of the first predetermined number of amino acids and the predetermined property. The target sequence setting section sets a predetermined peptide sequence used for comparing the hypotheses derived by the individual learning sections, and the target property extraction section extracts the properties specified by thus-set predetermined peptide sequence, respectively from the hypotheses derived by the individual learning sections. The variance evaluation section evaluates variance of the properties extracted from the individual learning sections, and the question point extraction section extracts a peptide sequence as an object to which a true data for the property of the hypothesis is requested, based on thus-evaluated variance, and thereby the individual hypotheses are compared. Further, the data updating section accepts the true data, correlates the true data to the extracted peptide sequence, and sends it to the data control section. The data control section updates the contents of the database, by adding data containing the peptide sequence and the property based on the true data. On the other hand, the sequence entry acceptance section accepts all amino acid sequences of a predetermined protein, extracts the peptide sequence candidates to be predicted from all amino acid sequences, and sends the peptide sequence candidates to the learning sections. The property estimation section estimates the property of the thus-extracted peptide sequence candidates, based on the results obtained from the individual learning sections.

In the sequence prediction system, the sequence candidate extraction section may extract a peptide sequence by a peptide fetching unit composed of a fifth predetermined number of amino acids from the head of all amino acid sequences accepted by the sequence entry acceptance section, and then extract the succeeding amino acid sequences by the above-described peptide fetching unit, at intervals of a sixth predetermined number of amino acids, shifted the subsequent peptide sequence candidates towards the downstream side. It is also allowable to exclude, from the extracted sequence candidates, any peptide sequences which satisfy a predetermined condition and in no need of prediction, before being sent to the learning sections.

According to this configuration, by extracting the peptide sequence candidates from the accepted all amino acid sequences of a protein, and by preliminarily excluding the unnecessary peptide sequences out of thus-extracted peptide sequences before prediction of the property, it becomes no more necessary for useless calculations for estimation.

In the sequence prediction system, the question point extraction section may extract, as the question point, the peptide sequences having variances within a seventh predetermined number of range away from the largest variance, or may extract, as the question point, the peptide sequences having variances larger than a predetermined value.

According to this configuration, it is made possible to continue extraction of the question point, until the hypotheses derived from the learning sections converge to a certain degree.

In the sequence prediction system, the hypothesis correction section may include a data request section requesting a true data of property with respect to the peptide sequences extracted by the question point extraction section, a data acceptance section accepting thus-requested true data, and a data addition section sending the accepted true data, as being correlated to the extracted peptide sequences, to the data control section.

According to this configuration, it is made possible to outsource experiments, or to request information to an external database, by supplying the true data from the data request section with respect to the peptide sequences as the question point. The data acceptance section accepts data corresponded to the true data, and the data addition section sends thus-accepted true data to the data control section so as to add them in the database as being correlated to the peptide sequences as an object to which the data was requested.

In the sequence prediction system, it is also allowable to further provide a sequence extraction section extracting the peptide sequence candidates having the property which satisfies the estimated predetermined conditions, out of the properties of the individual peptide sequence candidates estimated by the property estimation section.

According to this configuration, the property estimation section can extract the peptide sequence candidates having a predetermined property, as those expressing the predetermined property with respect to a predetermined protein.

This configuration is also characterized in that a base sequence of a nucleic acid coding the peptide sequence is predicted, based on the peptide sequence predicted by the above-described sequence prediction system.

It is therefore made possible to predict a base sequence of a nucleic acid coding the sequence candidate expressing a predetermined property with respect to a predetermined protein, based on the peptide sequences predicted by the above-described sequence prediction system.

One aspect of the sequence prediction support system includes a database having stored therein data containing peptide sequences each composed of a first predetermined number of amino acids, and a property providing an index of a predetermined biological activity of the peptide sequences; a plurality of learning sections deriving hypotheses for a third predetermined number of peptide sequences from the peptide sequences and the property, based on a second predetermined number of the data; a random re-sampling section fetching a fourth predetermined number of data from the database, and randomly supplying them to each of the learning sections by the second predetermined number of data; a target sequence setting section setting a predetermined peptide sequence contained in the hypotheses derived by the individual learning sections; a target property extraction section extracting respectively, from the hypotheses derived by each of the learning sections, the property specified by thus-set predetermined peptide sequences; a variance evaluation section evaluating variances of the property extracted from each of the learning sections; a question point extraction section extracting a peptide sequence as an object to which a true data for the property of the hypothesis is requested, based on thus-evaluated variance; a data updating section accepting the requested true data, and correlating the extracted peptide sequence with the property based on the true data; and a data control section accumulating a new data obtained by the data updating section as containing the peptide sequence and the property based on the true data, into the database.

According to this configuration, the fourth predetermined number of data are randomly re-sampled from the database by the random re-sampling section by the second predetermined number, smaller than a predetermined fourth number, of data at a time, and are sent to the individual learning sections. In this re-sampling, data different for every learning section are sent. In each of the learning sections, the sent data is analyzed to thereby generate a certain hypothesis, that is, a data set relevant to a predetermined property found for a third predetermined number of peptide sequences is derived, based on the peptide sequence composed of the first predetermined number of amino acids and the predetermined property. The target sequence setting section sets a predetermined peptide sequence used for comparing the hypotheses derived by the individual learning sections, and the target property extraction section extracts the properties specified by thus-set predetermined peptide sequence, respectively from the hypotheses derived by the individual learning sections. The variance evaluation section evaluates variance of the properties extracted from the individual learning sections, and the question point extraction section extracts a peptide sequence as an object to which a true data for the property of the hypothesis is requested, based on thus-evaluated variance, and thereby the individual hypotheses are compared. The data updating section accepts the true data, correlates the true data to the extracted peptide sequence, and sends it to the data control section. The data control section updates the contents of the database, by adding data containing the peptide sequence and the property based on the true data, and thereby the database supporting the sequence prediction is constructed.

One aspect of the sequence prediction program allows a computer to function as a sequence prediction system which includes a database having stored therein data containing peptide sequences each composed of a first predetermined number of amino acids, and a property providing an index of a predetermined biological activity of the peptide sequences; a plurality of learning sections deriving hypotheses for a third predetermined number of peptide sequences from the peptide sequences and the property, based on a second predetermined number of the data; a random re-sampling section fetching a fourth predetermined number of data from the database, and randomly supplying them to each of the learning sections by the second predetermined number of data at a time; a target sequence setting section setting a predetermined peptide sequence contained in the hypotheses derived by the individual learning sections; a target property extraction section extracting, from the hypotheses extracted by each of the learning sections, the property specified by thus-set predetermined peptide sequences; a variance evaluation section evaluating variances of the property extracted from each of the learning sections; a question point extraction section extracting a peptide sequence as an object to which a true data for the property of the hypothesis is requested, based on thus-evaluated variance; a data updating section accepting the requested true data, and correlating the extracted peptide sequence with the property based on the true data; a data control section accumulating a new data obtained by the data updating section as containing the peptide sequence and the property based on the true data, into the database; a sequence entry acceptance section accepting all amino acid sequences of a predetermined protein; a sequence candidate extraction section extracting peptide sequence candidates to be predicted, from all amino acid sequences accepted by the sequence entry acceptance section, and sending thus-extracted peptide sequence candidates to the learning sections; and a property estimation section estimating the property of the extracted peptide sequence candidates, based on results obtained from each of the learning sections.

According to this configuration, the fourth predetermined number of data are randomly re-sampled from the database by the random re-sampling section by the second predetermined number, smaller than a predetermined fourth number, of data at a time, and are sent to the individual learning sections. In this re-sampling, data different for every learning section are sent. In each of the learning sections, the sent data is analyzed to thereby generate a certain hypothesis, that is, a data set relevant to a predetermined property found for a third predetermined number of peptide sequences is derived, based on the peptide sequence composed of the first predetermined number of amino acids and the predetermined property. The target sequence setting section sets a predetermined peptide sequence used for comparing the hypotheses derived by the individual learning sections, and the target property extraction section extracts the properties specified by thus-set predetermined peptide sequence, respectively from the hypotheses derived by the individual learning sections. The variance evaluation section evaluates variance of the properties extracted from the individual learning sections, and the question point extraction section extracts a peptide sequence to which a true data for the property of the hypothesis is requested, based on thus-evaluated variance, and thereby the individual hypotheses are compared. The data updating section accepts the true data, correlates the true data to the extracted peptide sequence, and sends it to the data control section. The data control section updates the contents of the database, by adding data containing the peptide sequence and the property based on the true data. On the other hand, the sequence entry acceptance section accepts all amino acid sequences of a predetermined protein, extracts the peptide sequence candidates to be predicted from all amino acid sequences, and sends the peptide sequence candidates to the learning sections. The property estimation section estimates the property of thus-extracted peptide sequence candidates, based on the results obtained from the individual learning sections. In this way, a general-purpose computer device can function as a sequence prediction system.

One aspect of the sequence prediction support program allows a computer to function as a sequence prediction support system which includes a database having stored therein data containing peptide sequences each composed of a first predetermined number of amino acids, and a property providing an index of a predetermined biological activity of the peptide sequences; a plurality of learning sections deriving hypotheses for a third predetermined number of peptide sequences from the peptide sequences and the property, based on a second predetermined number of the data; a random re-sampling section fetching a fourth predetermined number of data from the database, and randomly supplying them to each of the learning sections by the second predetermined number of data at a time; a target sequence setting section setting a predetermined peptide sequence contained in the hypotheses derived by the individual learning sections; a target property extraction section extracting, from the hypotheses derived by each of the learning sections, the property specified by thus-set predetermined peptide sequences; a variance evaluation section evaluating variances of the property extracted from each of the learning sections; a question point extraction section extracting a peptide sequence as an object to which a true data for the property of the hypothesis is requested, based on thus-evaluated variance; a data updating section accepting the requested true data, and correlating the extracted peptide sequence with the property based on the true data; and a data control section accumulating a new data obtained by the data updating section as containing the peptide sequence and the property based on the true data, into the database.

According to this configuration, the fourth predetermined number of data are randomly re-sampled from the database by the random re-sampling section by the second predetermined number, smaller than a predetermined fourth number, of data, and are sent to the individual learning sections. In this re-sampling, data different for every learning section are sent. In each of the learning sections, the sent data is analyzed to thereby generate a certain hypothesis, that is, a data set relevant to a predetermined property found for a third predetermined number of peptide sequences is derived, based on the peptide sequence composed of the first predetermined number of amino acids and the predetermined property. The target sequence setting section sets a predetermined peptide sequence used for comparing the hypotheses derived by the individual learning sections, and the target property extraction section extracts the properties specified by thus-set predetermined peptide sequence, respectively from the hypotheses derived by the individual learning sections. The variance evaluation section evaluates variance of the properties extracted from the individual learning sections, and the question point extraction section extracts a peptide sequence as an object to which a true data for the property of the hypothesis is requested, based on thus-evaluated variance, and thereby the individual hypotheses are compared. The data updating section accepts the true data, correlates the true data to the extracted peptide sequence, and sends it to the data control section. Further, The data control section updates the contents of the database, by adding data containing the peptide sequence and the property based on the true data, and thereby the database supporting the sequence prediction is constructed. In this way, a general-purpose computer device can function as a sequence prediction support system.

Another aspect of the sequence prediction system includes a database having stored therein data containing peptide sequences each composed of a first predetermined number of amino acids, and the property providing an index of a predetermined biological activity of the peptide sequences; a plurality of hypothesis derivation section randomly fetching a fourth predetermined number of data from the database, and deriving hypotheses for a third predetermined number of peptide sequences from the peptide sequences and the property, based on a second predetermined number of the data randomly sent out of the fourth predetermined number of data; a question point sequence extraction section setting predetermined peptide sequences contained in the hypotheses derived by each of the hypothesis derivation sections, extracting the property specified by thus-set predetermined peptide sequences respectively from the hypotheses derived by each of the hypothesis derivation sections, evaluating variance of thus-extracted property, and extracting a peptide sequence as an object to which a true data for the property of the hypothesis is requested, based on thus-evaluated variance; a data updating section accepting the requested true data, and correlating the extracted peptide sequence with the property based on the true data; a data control section accumulating a new data obtained by the data updating section as containing the peptide sequence and the property based on the true data, into the database; and a property estimation/output section accepting all amino acid sequences of a predetermined protein, extracting peptide sequence candidates to be predicted, from thus-accepted all amino acid sequence, sending thus-extracted peptide sequence candidates to the hypothesis derivation section, and estimating the property of thus-extracted peptide sequence candidates based on the output results.

In the sequence prediction system, it is also allowable to further provide a sequence extraction section extracting the peptide sequence candidates having the property which satisfies the estimated predetermined condition, out of the properties of the individual peptide sequence candidates estimated by the property estimation/output section.

Another aspect of the sequence prediction support system includes a database having stored therein data containing peptide sequences each composed of a first predetermined number of amino acids, and the property providing an index of a predetermined biological activity of the peptide sequences; a plurality of hypothesis derivation section randomly fetching a fourth predetermined number of data from the database, and deriving hypotheses for a third predetermined number of peptide sequences from the peptide sequences and the property, based on a second predetermined number of the data randomly sent out of the fourth predetermined number of data; a question point sequence extraction section setting predetermined peptide sequences contained in the hypotheses derived by each of the hypothesis derivation sections, extracting the property specified by thus-set predetermined peptide sequences respectively from the hypotheses derived by each of the hypothesis derivation sections, evaluating variance of thus-extracted property, and extracting a peptide sequence as an object to which a true data for the property of the hypothesis is requested, based on thus-evaluated variance; a data updating section accepting the requested true data, and correlating the extracted peptide sequence with the property based on the true data; and a data control section accumulating a new data obtained by the data updating section as containing the peptide sequence and the property based on the true data, into the database.

One aspect of the sequence prediction program allows a computer device to function as a sequence prediction system which includes a database having stored therein data containing peptide sequences each composed of a first predetermined number of amino acids, and the property providing an index of a predetermined biological activity of the peptide sequences; a plurality of hypothesis derivation section randomly fetching a fourth predetermined number of data from the database, and deriving hypotheses for a third predetermined number of peptide sequences from the peptide sequences and the property, based on a second predetermined number of the data randomly sent out of the fourth predetermined number of data; a question point sequence extraction section setting predetermined peptide sequences contained in the hypotheses derived by each of the hypothesis derivation sections, extracting the property specified by thus-set predetermined peptide sequences respectively from the hypotheses derived by each of the hypothesis derivation sections, evaluating variance of thus-extracted the property, and extracting a peptide sequence to which a true data for the property of the hypothesis is requested, based on thus-evaluated variance; a data updating section accepting the requested true data, and correlating the extracted peptide sequence with the property based on the true data; a data control section accumulating a new data obtained by the data updating section as containing the peptide sequence and the property based on the true data, into the database; and a property estimation/output section accepting all amino acid sequences of a predetermined protein, extracting peptide sequence candidates to be predicted, from thus-accepted all amino acid sequence, sending thus-extracted peptide sequence candidates to the hypothesis derivation section, and estimating the property of thus-extracted peptide sequence candidates based on the output results.

One aspect of the sequence prediction support program allows a computer device to function as a sequence prediction support system which includes a database having stored therein data containing peptide sequences each composed of a first predetermined number of amino acids, and the property providing an index of a predetermined biological activity of the peptide sequences; a plurality of hypothesis derivation section randomly fetching a fourth predetermined number of data from the database, and deriving hypotheses for a third predetermined number of peptide sequences from the peptide sequences and the property, based on a second predetermined number of the data randomly sent out of the fourth predetermined number of data; a question point sequence extraction section setting predetermined peptide sequences contained in the hypotheses derived by each of the hypothesis derivation sections, extracting the property specified by thus-set predetermined peptide sequences respectively from the hypotheses derived by each of the hypothesis derivation sections, evaluating variance of thus-extracted property, and extracting a peptide sequence to which a true data for the property of the hypothesis is requested, based on thus-evaluated variance; a data updating section accepting the requested true data, and correlating the extracted peptide sequence with the property based on the true data; and a data control section accumulating a new data obtained by the data updating section as containing the peptide sequence and the property based on the true data, into the database.

One aspect of the method of sequence prediction includes a random re-sampling step of fetching a fourth predetermined number of data using a random re-sampling section, from a database having stored therein data containing peptide sequences each composed of a first predetermined number of amino acids, and a property providing an index of a predetermined biological activity of the peptide sequence, and randomly supplying a second predetermined number of data out of the fourth predetermined number of data to each of a plurality of learning sections; a hypotheses derivation step deriving, in each of the learning sections, hypothesis found for a third predetermined number of peptide sequences, from the peptide sequences and the property based on the second predetermined number of data; a target sequence setting step setting a predetermined peptide sequence contained in the hypotheses derived by the individual learning sections; a target property extraction step extracting the property specified by thus-set predetermined peptide sequences from the hypotheses derived by the individual learning sections; a variance evaluation step evaluating variance as an object the property extracted by the individual learning sections; a question point extraction step extracting a peptide sequence to which a true data for the property of the hypothesis is requested, based on thus-evaluated variance; a data updating step accepting the requested true data, correlating the extracted peptide sequence with the property based on the true data, and accumulating a new additional data containing thus-obtained peptide sequence and the property based on the true data into the database; a sequence candidate extraction step accepting all amino acid sequences of a predetermined protein, extracting peptide sequence candidates to be predicted from thus-accepted all amino acid sequences, and sending thus-extracted peptide sequence candidates to the learning sections; and a property estimation step estimating the property of the extracted peptide sequence candidates, based on results obtained from each of the learning sections.

Also a method of supporting sequence prediction as described below is included in the aspects of the present invention. That is, the method of supporting sequence prediction includes a random re-sampling step of fetching a fourth predetermined number of data in a random re-sampling section, from a database having stored therein data containing peptide sequences each composed of a first predetermined number of amino acids, and a property providing an index of a predetermined biological activity of the peptide sequence, and randomly supplying a second predetermined number of data out of the fourth predetermined number of data to each of a plurality of learning sections; a hypotheses derivation step deriving, in each of the learning sections, hypothesis found for a third predetermined number of peptide sequences, from the peptide sequences and the property based on the second predetermined number of data; a target sequence setting step setting a predetermined peptide sequence contained in the hypotheses derived by the individual learning sections; a target property extraction step extracting the property specified by thus-set predetermined peptide sequences from the hypotheses derived by the individual learning sections; a variance evaluation step evaluating variance in the property extracted by the individual learning sections; a question point extraction step extracting a peptide sequence as an object to which a true data for the property of the hypothesis is requested, based on thus-evaluated variance; and a data updating step accepting the requested true data, correlating the extracted peptide sequence with the property based on the true data, and accumulating a new additional data containing thus-obtained peptide sequence and the property based on the true data.

According to the present invention, it is made possible to select only a biopolymer sequence having a predetermined property, without relying upon experiments.

### BRIEF DESCRIPTION OF THE DRAWINGS

The above and other objects, features and advantages of the present invention will be more apparent from the following description taken in conjunction with the accompanying drawings listed below.

FIG. 1 is a block diagram showing an outline of a sequence prediction system according to a first embodiment of the present invention;

FIG. 2 is a chart showing exemplary data sets accumulated in the storage device;

FIG. 3 is a drawing showing an exemplary incidence of individual amino acids at the individual in-line positions on a hypothetical peptide sequence, summed up based on probability parameters calculated by the learning section;

FIG. 4 is a chart showing exemplary hypotheses output by the learning section;

FIG. 5 is a chart schematically showing exemplary data for extracting question points;

FIG. 6 is a drawing showing an exemplary sequence candidate extraction section configured as excluding unnecessary peptide sequences;

FIG. 7 is a block diagram showing an outline of a sequence prediction system according to a second embodiment of the present invention;

FIG. 8 is a functional block diagram explaining functions of the hypothesis comparison section shown in FIG. 7;

FIG. 9 is a diagram showing a case where the true data is requested to an external database, rather than to the user;

FIG. 10 is a flow chart explaining operations of a method of supporting sequence prediction according to the first embodiment;

FIG. 11 is a flow chart showing operations of a sequence prediction system using a database constructed by the sequence prediction support system, or an available database;

FIG. 12 is a flow chart explaining operations of a method of supporting sequence prediction according to the second embodiment; and

FIG. 13 is a flow chart showing operations of a sequence prediction system using a database constructed by the sequence prediction support system, according to the second embodiment.

### BEST MODES FOR CARRYING OUT THE INVENTION

Embodiments of the present invention will be explained below, referring to the drawings. It is to be noted that any similar constituents are given with similar reference numerals, so as not to repeat explanations on occasions.

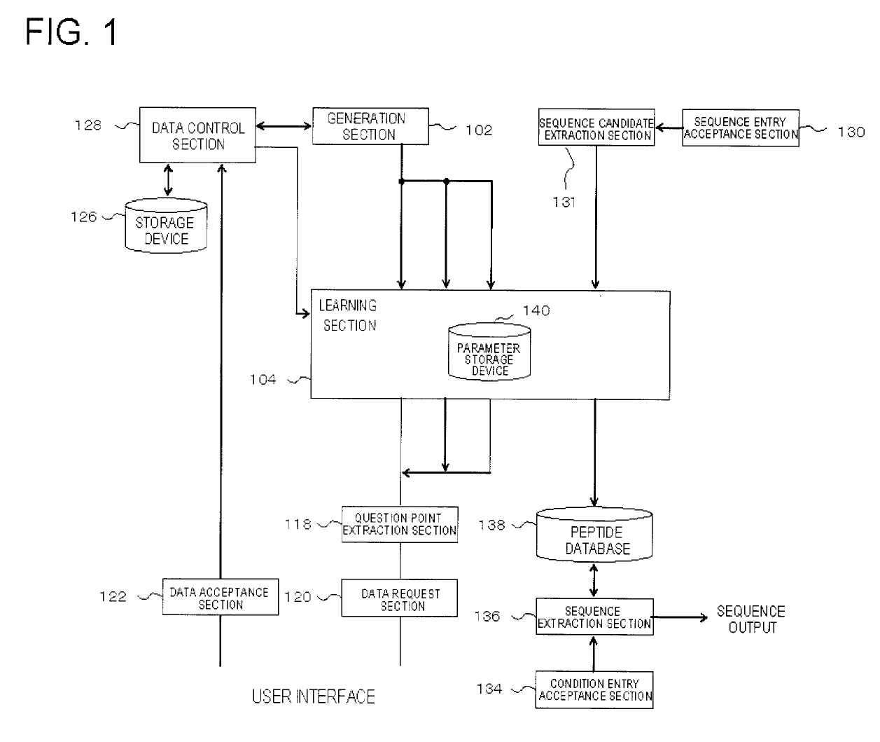

FIG. 1 is a block diagram showing an outline of the sequence prediction system according to the first embodiment of the present invention.

This sequence prediction system includes a storage device 126 as the database having biopolymer attributes which contain sequences of a biopolymer, and add values owned by the biopolymer having the sequences; a data control section 128 as the selection section selecting N data sets from the storage device 126; a generation section 102 generating a different plurality of data subsets from the data sets; a learning section 104 generating a hypothesis for each of the individual data subsets, applying the hypotheses respectively to the second data sets composed of biopolymer sequences independent of the data sets, to thereby derive add values of the biopolymer sequences relevant to the second data sets; a question point extraction section 118 finding variances of the add values for the individual biopolymer sequences in the second data sets, and extracting, as question points, biopolymer sequences having variances larger than a predetermined reference level; a data control section 128 accepting the add values corresponded to the question point, and accumulating the accepted add values in the storage device 126 so as to correlate them with the biopolymer sequences relevant to the question point; a sequence entry acceptance section 130 accepting all sequences of a predetermined biopolymer; a sequence candidate extraction section 131 extracting biopolymer sequence candidates to be predicted, from all sequences accepted by the sequence entry acceptance section 130; and the learning section 104 as an add value estimation section generating, after acceptance of the sequences, a law based on all data sets of the database in the storage device 126, and applying the law respectively to the biopolymer sequence candidates, to thereby estimate add values of the biopolymer sequence candidates.

The storage device 126 shown in FIG. 1 is a database having accumulated therein data sets which contain a peptide sequence as a biopolymer sequence, and add values of the peptide sequence. The data sets are composed of available data already made clear by literatures (referred to as “known data”), or data sent from a data acceptance section 122 through the data control section 128 described later.

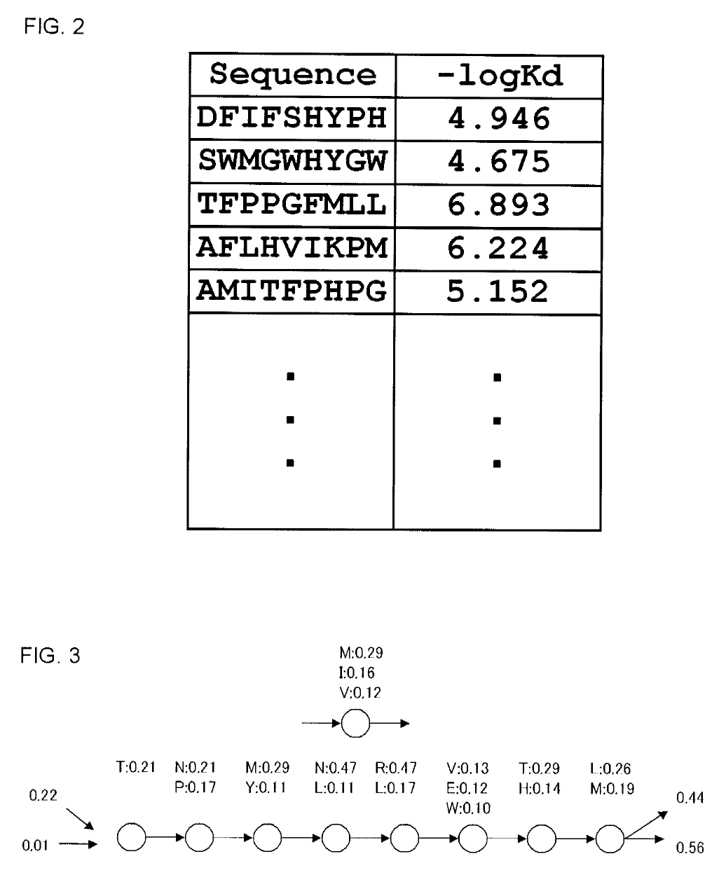

FIG. 2 is a chart showing exemplary data sets accumulated in the storage device 126.

As shown in FIG. 2, the data sets contain peptide sequences each composed of a predetermined number of amino acids, and an add value of the peptide sequences, such as a property providing an index of a predetermined biological activity, such as binding constant (-logKd) with human leukocyte antigen (HLA) complex, which is an antigen presentation molecule closely related to immunity induction. The number of amino acids in the peptide sequences can be set to a fixed value from 8 to 11, 9 for example, for the case where HLA Class-I molecule is targeted at, and to a fixed value of 20 or smaller, for the case where HLA Class-II molecule is targeted at.

Although this embodiment will be explained while exemplifying, as the biopolymer sequence, the peptide sequence aimed at binding with HLA as an antigen-presenting molecule, the biopolymer sequence may be any of those having other biological activities, such as a peptide sequence targeted at G-protein-coupled receptor having a peptide ligand, or may be a base sequence of nucleic acid (DNA, etc.) coding the above-described predetermined peptide sequence. The biopolymer having a predetermined biological activity also includes, besides the peptide sequence, DNA and RNA composed of a predetermined number of nucleotides, and thereby has a predetermined base sequence.

The add value of the biopolymer sequence can be exemplified by property which provides an index of binding ability with a predetermined substance, wherein the property not only includes binding constant with a binding target, but also may include the property concerning binding such as hydrophobicity (or hydrophilicity).

Turning now back to FIG. 1, the data control section 128 functions as a selection section selecting N data sets, and the selected N data sets are sent to the generation section 102. In the data control section 128, as described later, contents of data in the storage device 126 are updated by sending additional data sets sent from the data acceptance section 122 to the storage device 126.

In the data control section 128, upon entry of all sequences of a predetermined biopolymer from the sequence entry acceptance section 130 described later, all data sets are fetched from the data sets accumulated in the storage device 126, and sent to the learning section 104 as the add value estimation section.

The generation section 102 randomly samples among N data sets sent from the data control section 128, to thereby generate data subsets composed of arbitrary m (N>m) data, and sends the individual data subsets to the learning section 104.

In this case, when 100 data sets, for example, are sent from the data control section 128, typically 50 data sets out of 100 are randomly sampled, to thereby generate a first data subset, and other 50 data sets different from those of the first data subset are then sampled out of 100, to thereby generate a second data subset. In this way, a plurality of, for example 50, data subsets are generated. The individual data subsets may be data sets of the same number, or may be data sets of different numbers.

In the learning section 104, hypotheses described later are generated for each of the data subsets, when the data subsets are sent from the generation section 102, whereas an add value corresponded to the candidate peptide sequences described later, such as a law for estimating the binding constant shown in FIG. 2, is generated, when the data sets are sent from the data control section 128.

The learning section 104 herein may be configured as having a plurality of processing sections, so as to allow the individual processing sections to execute processing regarding a plurality of data subsets in a parallel manner, or as having only a single processing section, so as to execute serial processing for every data subset.

In both cases, operations are proceeded according to procedures of a hidden-Markov-model learning system described typically in Japanese Patent Publication No. 3094860.

When 50 data subsets, for example, are sent from the generation section 102, the learning section 104 calculates probability for each data subsets, and results of the calculation are accumulated in a parameter storage device 140. For an exemplary case of a hypothesis regarding a peptide sequence composed of a predetermined number, 9 for example, of amino acids, probability parameters accumulated in the parameter storage device 140 include incidences of the individual amino acids at the individual in-line positions in the individual order of arrangement, and transition probabilities at positions immediately before and after the individual in-line positions.

Based on the incidences of the individual amino acids at the individual in-line positions, and the transition probabilities before and after the individual in-line positions, incidences of the individual amino acids at the individual in-line positions in a virtual peptide sequence, such as shown in FIG. 3, are calculated as the hypotheses. In FIG. 3, the upper row shows results indicating that the first or ninth amino acid will have methionine (M) with a probability of 29%, isoleucine (I) with a probability of 16%, and valine (V) with a probability of 12%. Residual 43% is calculated as a total incidence of the residual amino acids. The lower row in FIG. 3 shows in-line positions of 8 amino acids one by one from the left to the right. From this results, it is known that the leftmost threonine (T) will fall on the first position with a probability of 1%, and on the second position with a probability of 22%. In this way, the incidences are shown rightwardly, wherein amino acids within the top-three incidence are shown on the upper side of the individual in-line positions. Therefore, the parameter storage device 140 is configured so as to accumulate the individual probability parameters used for summing the hypotheses composed of such parameters.

Relation between probability calculation of peptide sequence and binding constant is described in non-patent document, the outline of which will be explained below.

A logarithmic value logKa of binding constant Ka with respect to a specific peptide O is given by the equation below:

LKa=L_{O/H}−C

or,

LKa=L_{O/H}−(L_{O/H′}−LKa′)

where, L_{O/H} represent an incidence of the peptide sequence O in a given HMM (hidden Markov model).

LogKd, or C in the equation, is given by C=L_{O/H′}−LKa′, where, LKa′ represent an average value of logKa of all peptides used for the calculation.

H′ represent a reference HMM for the case with a uniform incidence.

In the learning section 104, the hypotheses are applied respectively to the second data sets composed of the biopolymer sequences independent of the data sets fetched by the data control section 128, thereby the add values of the biopolymer sequences relevant to the second data sets are derived, and sent to the question point extraction section 118. The second data sets include, for example, 100,000 peptide sequences, the hypotheses derived from the plurality of data sets are respectively applied to the second data sets, and thereby the second data sets composed of 100,000 peptide sequences and the add values of the individual sequences are generated with the number of quantity same as that of the data subsets. The peptide sequence relevant to the second data sets may be variable sets which are set every time the data subset is sent from the generation section 102, or may be a set which is arbitrarily entered or selected by the user of the system. It may still also be the one contained in a predetermined data table.

On the other hand, when the data sets are sent from the data control section 128, it functions as the add value estimation section. In other words, the operations similar to those described in the above are executed, and a law is generated based on the obtained probability parameters. Unlike the case of generating the hypotheses, only a single law is generated. Estimated values obtained by applying the law are obtained for each of the candidate peptide sequences sent from the sequence candidate extraction section 131 described later, and the estimated values are sent to a peptide database 138, as being correlated to the add values of the correspondent candidate peptide sequences.

In the question point extraction section 118, variances in the add values are calculated for each of the peptide sequences in the second data sets.

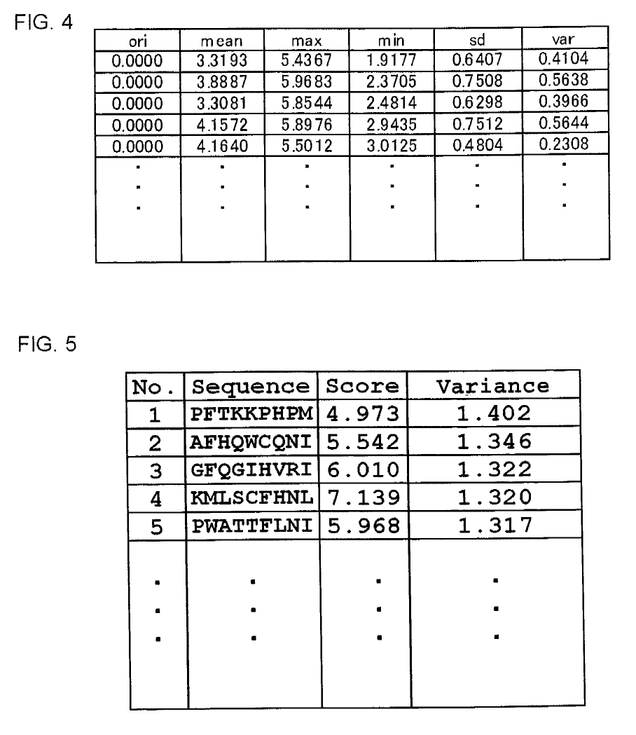

FIG. 4 shows exemplary results of the calculation.

In FIG. 4, “ori” represents a binding constant as a temporary score of the add values from which the calculation originates in the learning section 104, to which an initial value of 0.0000 is given for all peptide sequences. “Mean” expresses mean values of predicted scores derived for every specific peptide sequence in the second data sets, “max” in the same row expresses maximum values of the predicted scores, “min” in the same row expresses minimum values of the predicted scores, “sd” in the same row expresses standard deviations of the predicted scores, and “var” in the same row expresses variances of the predicted scores.

Next, the question point extraction section 118 fetches the sequences in a decreasing order of variance. FIG. 5 schematically shows a ranking among the data sets. Of these data sets, the peptide sequences as the biopolymer sequences having variances within a predetermined range, for example in a top-50 range, are extracted as the question point, and thus-extracted peptide sequences are sent to the data request section 120. It is also allowable that the peptide sequences having variances larger than a predetermined value are extracted as the question point.

The data request section 120 requests data expressing true add values, which are for example measured data obtained by experiments or literature data accumulated in an external database, with respect to the peptide sequences regarding the question point extracted by the question point extraction section 118. The data acceptance section 122 accepts the measured data entered by the user or literature data or the like obtained typically from a predetermined database or the like as described later, in response to the request issued by the data request section 120, and sends these data, as the true add values, to the data control section 128.

In the data control section 128, the data sent from the data acceptance section 122 and the peptide sequence which remained as the question point are correlated, thereby the additional data sets containing the peptide sequences and the add values relevant to the data are generated, and then sent to the storage device 126. As described in the above, the additional data sets are accumulated in the storage device 126, and are served as data candidates for the next and subsequent derivation of the hypotheses.

The sequence entry acceptance section 130 accepts entry of information on all amino acid sequences of a predetermined protein used for specifying peptide sequence candidates which are desired to be predicted, such as a target protein in need of identification of epitope, such as all amino acid sequences of a protein forming a viral antigen, and sends the accepted data to the sequence candidate extraction section 131. The entry may be made by using a predetermined input device through a user interface, or through a network by connecting the user interface to the network.

Target proteins other than viral antigen include bacteria relating to infectious diseases, such as Mycobacterium tuberculosis, O-157 bacteria, Salmonella enterica, Psuedomonas aeruginosa, Helicobacter pylori, Staphylococcus aureus, Plasmodium, Clostridium botulinum, etc.; proteins related allergic disease such as type-I diabetes, Sjogren's syndrome, pollinosis, atopy, asthma, rheumatism, connective tissue disease, autoimmune disease, anti-rejection after organ transplantation, etc.; proteins related to cancer immunity, such as cancer antigen; proteins related to Alzheimer's disease, such as beta-amyloid, a causal protein.

The sequence candidate extraction section 131 extracts the peptide sequence candidates to be predicted, based on all amino acid sequences of the predominant proteins, which is the information accepted by the sequence entry acceptance section 130, and the extracted peptide sequence candidates are sent to the learning section 104.

The peptide sequences extracted by the sequence candidate extraction section 131 may contain sequences actually not usable. Such unnecessary sequence may automatically be excluded without human operation.

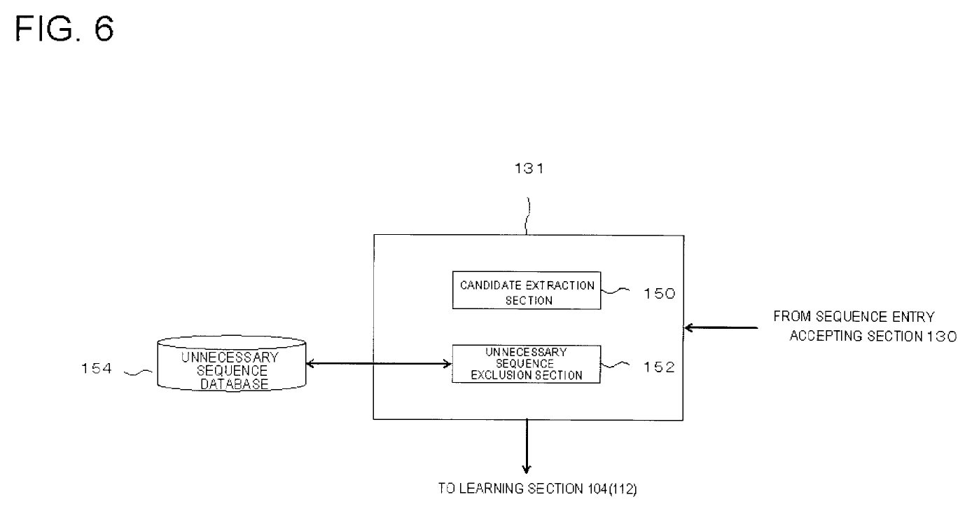

FIG. 6 shows an example of the sequence candidate extraction section 131 configured so as to exclude the unnecessary peptide sequences.

The sequence candidate extraction section 131 has, as being provided therein, a candidate fetch section 150 extracting the peptide sequence candidates by “p” monomer units which is peptide fetching units composed of, for example, 8 to 11, and more specifically 9 amino acids from all amino acid sequences of a predetermined protein sent from the sequence entry acceptance section 130, and an unnecessary sequence exclusion section 152 excluding, from thus-fetched peptide sequence candidates, the peptide sequences which satisfy a predetermined condition, and in no need of prediction.

The candidate fetch section 150 is configured so as to extract a peptide sequence by the above-described peptide fetch unit at a time, from the head of all amino acid sequences accepted by the sequence entry acceptance section 130, and then extracts the succeeding peptide sequence candidates by the above-described peptide fetch unit at a time, at every “q”-monomer-unit intervals, such as shifted towards the downstream side at intervals of a single amino acid.

The unnecessary sequence exclusion section 152 is configured so as to judge, out of thus-fetched peptide sequence candidates, the peptide sequences which satisfy a predetermined condition, and in no need of prediction, such as the peptide sequences specified referring to an unnecessary sequence database 154 having data regarding the unnecessary peptide sequences accumulated therein, as being unnecessary, and so as to exclude them from the candidates for prediction before being sent to the learning section 104, but so as to send the residual peptide sequence candidates to the learning section 104. The unnecessary peptide sequences herein can be exemplified, for example, by poor soluble peptide sequences.

For an exemplary case where a viral antigen for which the epitope thereof, accepted by the sequence entry acceptance section 130, is to be identified, such as for the case where the CTL epitope of hepatitis C virus is to be identified, it is configured so as to extract the peptide sequence candidates capable of acting as the epitope, from all amino acid sequences of an antigen protein of hepatitis C virus. For example, it is known that the antigen of hepatitis C virus is composed of 8 to 11 amino acids presented to human leukocyte antigen (HLA) Class-I molecule, and the CTL recognizes this portion to thereby injure hepatitis C virus. Therefore, the peptide sequences are fetched by the peptide fetching unit while shifting the head amino acid by a single amino acid towards the down stream side, such as fetching by a unit of 8 to 11 amino acids at a time, as the “p” monomer unit for fetching, from the head of all amino acid sequences of hepatitis C virus antigen, followed by fetching by a unit of 8 to 11 amino acids as described in the above, started from the amino acid shifted from the head by a unit of q monomers, for example started from the second amino acid shifted by a single amino acid, wherein thus-fetched peptide sequences are extracted as peptide sequences candidates desired for estimating of the add value.

It is also allowable to identify the epitope capable of recognizing Class-II molecule, wherein in this case, the peptide sequences are extracted in a similar manner while setting the p-monomer unit to 20 or below, or while setting the peptide fetch unit as being composed of 20 or less amino acids, wherein thus-fetched peptide sequences can serve as the candidate peptide sequences desired for the estimation of the add value.

According to this configuration, by extracting the candidate peptide sequence from the accepted all amino acid sequences of protein, and by excluding of the unnecessary peptide sequences out of thus-extracted peptide sequences before prediction of the property, it becomes no more necessary to execute useless calculations for estimation in the learning section 104.

The unnecessary sequence database 154 may form a part of the storage device 126. In this case, a part of data shown in FIG. 2 may be added with data regarding properties such as hydrophobicity.

This embodiment can be utilized, example for the purpose of extracting peptide sequence candidates necessary for developing a new drug, by composing the data accumulated in the unnecessary sequence database 154 so as to contain information on peptide sequences which should be licensed by other companies thereby to exclude such peptide sequence.

The peptide database 138 accumulates therein data sets composed of the add values estimated by the learning section 104, such as binding constant with HLA Class-A molecule, as being combined with the peptide sequences having the binding constant.

The condition entry acceptance section 134 accepts entry of the add values which provide a keyword for extracting peptide sequences having a predetermined property from the peptide database 138, such as binding constant. The entry may be made by using a predetermined input device through a user interface, or through a network by connecting the user interface to the network.

The entry accepted herein is a condition (add value) requested depending on the applicant for the peptide sequences to be extracted. For an exemplary case where the peptide sequence is used as a therapeutic drug for hepatitis C, the condition entry acceptance section 134 is configured so as to accept only keywords indicating a binding constant of 6 or above with respect to HLA Class-A molecule which is the predetermined protein.

The sequence extraction section 136 extracts the peptide sequences which satisfy the condition accepted by the condition entry acceptance section 134 from the peptide database 138, and outputs thus-extracted peptide sequences as results of prediction.

For the case where it is desired to search, using a peptide sequence once predicted, property of a novel peptide sequence obtained by substituting one to several amino acids of this peptide sequence, the sequence entry acceptance section 130 may accept relevant entries such as the peptide sequences for which the binding constant is predicted, and such as information regarding how many amino acids in these peptide sequences will be substituted, then the learning section 104 may execute calculation in the prediction step, to thereby be able to estimate the add value of the novel peptide based on results of the calculation.

Direct calculation for prediction of epitope can be realized herein, by allowing the learning section 104 to output, as the hypotheses, a list of 9 amino acids derived from an amino acid sequence of another predetermined protein, such as a target protein, such as a viral antigen, in place of the peptide sequences relevant to the second data sets for deriving the hypotheses and corresponded add values, that is, values of the binding constant. The number of peptide sequence for which the add values are derived is not limited to 100,000, whereas it is also allowable to predict all combinations of the peptide sequences by allowing the learning section 104 to output all combinations of the peptide sequences which totals 20⁹ if the add values of a peptide sequence composed of 9 amino acids are predicted.

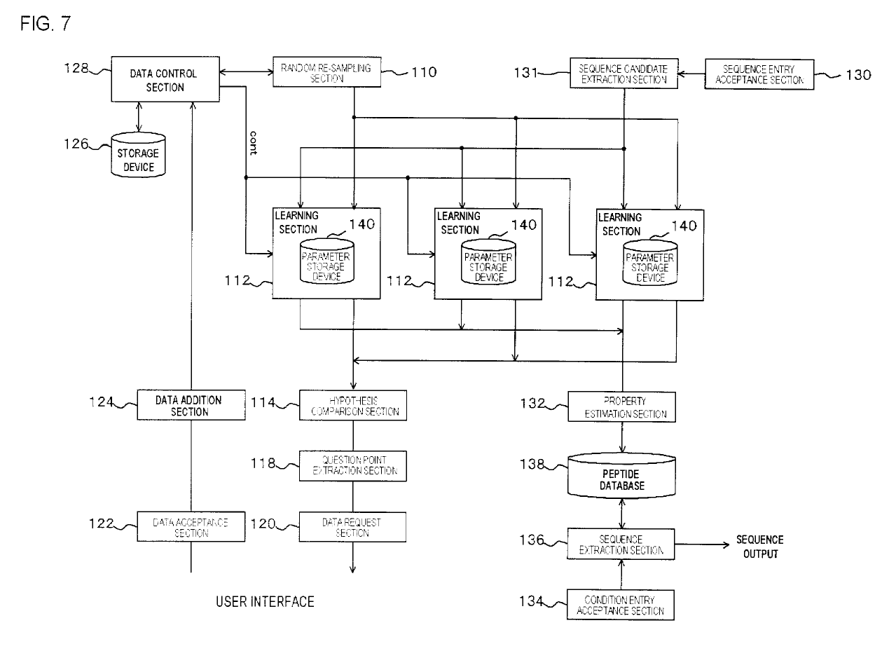

FIG. 7 is a block diagram showing an outline of a sequence prediction system according to the second embodiment of the present invention.

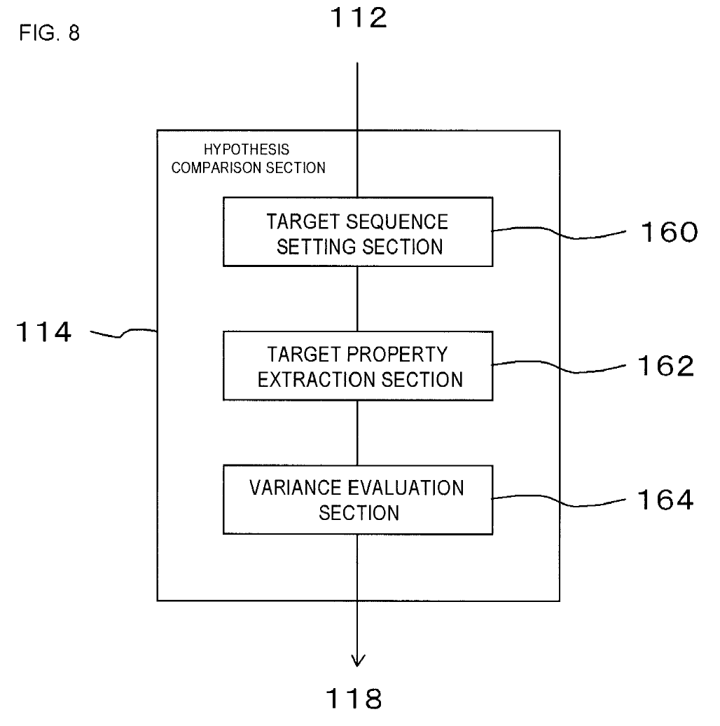

The sequence prediction system includes the storage device 126 as a database having stored therein data containing peptide sequences each composed of a first predetermined number of amino acids, and a property providing an index of a predetermined biological activity of the peptide sequences; a hypothesis derivation section composed of a plurality of learning sections 112 deriving hypotheses for a third predetermined number of peptide sequences from the peptide sequences and the property, based on a second predetermined number of the data, and a random re-sampling section 110 fetching a fourth predetermined number of data from the storage device 126, and randomly supplying them to each of the learning sections 112 by the second predetermined number of data at a time; a hypothesis comparison section 114 composed of a target sequence setting section 160 (FIG. 8) setting a predetermined peptide sequence contained in the hypotheses derived by the individual learning sections 112, a target property extraction section 162 (FIG. 8) extracting, from the hypotheses derived by each of the learning sections 112, the property specified by thus-set predetermined peptide sequences, and a variance evaluation section 164 (FIG. 8) evaluating variances of the property extracted from each of the learning sections 112; the question point sequence extraction section configured by a question point extraction section 118 extracting a peptide sequence as an object to which a true data for the property of the hypothesis is requested, based on thus-evaluated variance; the data request section 120 composing a data updating section accepting the requested true data, and correlating the extracted peptide sequence with the property based on the true data; the data control section 128 accumulating a new data obtained by the data acceptance section 122, a data addition section and the data updating section, as containing the peptide sequence and the property based on the true data, into the storage device 126; and a property prediction output section composed of the sequence entry acceptance section 130 accepting all amino acid sequences of a predetermined protein, the sequence candidate extraction section 131 extracting peptide sequence candidates to be predicted, from all amino acid sequences accepted by the sequence entry acceptance section 130, and sending thus-extracted peptide sequence candidates to the learning sections 112, and a property estimation section 132 estimating the property of the extracted peptide sequence candidates, based on results obtained from each of the learning sections 112.

In FIG. 7, the storage device 126 is a database having accumulating therein data sets of available data already made clear by literatures (referred to as “known data”), containing peptide sequences each composed of a first predetermined number of amino acids, and a property providing an index of a predetermined biological activity of the peptide sequence. As described later, the storage device 126 can be updated using additional data sent through the data control section 128.

FIG. 2 is a chart showing exemplary data sets accumulated in the storage device 126

As shown in FIG. 2, the data sets contain peptide sequences each composed of a predetermined number of amino acids, shown by the known data and by additional data as the true data, and an add value of the peptide sequences, a property providing an index of a predetermined biological activity, such as binding constant (-logKd) with respect to human leukocyte antigen (HLA) complex, which is an antigen presentation molecule closely related to immunity induction. The number of amino acids in the peptide sequences can be set to a fixed value from 8 to 11, 9 for example, for the case where HLA Class-I molecule is targeted at, and to a fixed value of 20 or smaller, for the case where HLA Class-II molecule is targeted at.

Although this embodiment has explained the case of where the peptide sequence to be determined was the peptide sequence aimed at binding with HLA as an antigen-presenting molecule, the peptide sequence may be any of those having other biological activities, such as a peptide sequence targeted at G-protein-coupled receptor having a peptide ligand, or may be a base sequence of nucleic acid (DNA, etc.) coding the above-described predetermined peptide sequence.

The property providing an index for binding ability to a predetermined substance may be a property relevant to binding, such as hydrophobicity (or hydrophilicity), other than the binding constant with respect to a binding target.

Turning now back to FIG. 7, in the data control section 128, the additional data, derived by the individual learning sections 112 based on the data re-sampled by the random re-sampling section 110 described later, and optionally containing, if necessary, the true data added by the data addition section 124 described later, is sent to the storage device 126, and thereby the data set to be accumulated in the storage device 126 is updated.

The random re-sampling section 110 randomly re-samples the second predetermined number of data out of the fourth predetermined number of data sent from the data control section 128, and supplies the data to the individual learning section 112.

The linked operation of the data control section 128 and the random re-sampling section 110 makes it possible to randomly supply the same number of different data (samples) to the individual learning sections 112. For an exemplary case where 100 data, as the fourth predetermined number of data, are fetched from the storage device 126, and 50 data, as the second predetermined number of data, are to be supplied to the individual learning sections 112, 50 data out of 100 are fetched by random re-sampling, the fetched data are sent to one learning section 112, then another 50 data are fetched by random re-sampling, the fetched data are sent to another learning section 112, finally 50 different data are supplied to all learning sections, instead of sending the same data to all learning sections 112. This procedure can successfully avoid derivation of identical hypotheses from the individual learning sections 112. In this way, only as much as several hundreds of measured values (literature values) allows prediction by this system.

The learning section 112 is configured to execute processing in the learning phase and the estimation phase, depending on the purposes thereof. When the input data are those sent from the data control section 128 through the random re-sampling section 110, the data control section 128 is designed to send a control signal “cont” to the individual learning sections 112 so as to prompt calculation of the learning phase, and the learning section 112 executes the calculation of the learning phase, if the control signal “cont” is entered. On the other hand, when the data based on data sent from the sequence entry acceptance section 130 described later are sent, the calculation of the estimation phase is executed.

In both of the learning phase and the estimation phase, a probability is calculated by the plurality of, 50 for example, learning sections using input data, following procedures of the hidden-Markov-model learning system such as described in Japanese Patent Publication No. 3094860, and the results of calculation are accumulated into the parameter storage device 140. Probability parameters accumulated in the parameter storage device 140 include incidence of the individual amino acids at the individual in-line positions in a peptide sequence composed of a first predetermined number, 9 for example, of amino acids, and transition probabilities at positions immediately before and after the individual in-line positions.

In the learning phase, based on calculation corresponding to the probability parameters accumulated in the parameter storage device 140, the incidences of the individual amino acids at the individual in-line positions in the virtual peptide sequence as shown in FIG. 3 in the above are obtained.

Now, aimed at obtaining a preliminarily-set predetermined number of combinations of data, predicted scores corresponded to the binding constant are calculated based on the results of calculation shown in FIG. 3, with respect to the third predetermined number of, 100,000 for example, peptide sequences, and thereby the hypothetical data is obtained. The hypothetical data is sent to the hypothesis comparison section 114. For the case where the data sets in the storage device 126 may be updated therein using the hypothetical data, it is also allowable to send the hypothetical data to the data control section 128. The third predetermined number of peptide sequence sets may be variable sets which are set every time the calculation in the learning phase starts, or may be a set which is arbitrarily entered or selected by the user of the system.

On the other hand, the calculation in the estimation phase is executed almost similarly to the calculation in the learning phase, wherein the scores of binding constant corresponded to the individual peptide sequence obtained in the individual learning sections 112 are sent to the property estimation section 132 described later, rather than to the hypothesis comparison section 114.

The probability parameters accumulated in the parameter storage device 140 are overwritten every time the data are randomly re-sampled in the learning phase, whereas in the estimation phase, the probability parameter finally remained as being accumulated is used for calculation of the scores.

FIG. 8 shows a functional block diagram explaining functions of the hypothesis comparison section 114.

The hypothesis comparison section 114 is composed of the target sequence setting section 160, the target property extraction section 162, and the variance evaluation section 164.

The target sequence setting section 160 sets a peptide sequence which serves as a target for comparison used for judging to what degree the hypotheses derived from the individual learning sections 112 converge. Thus-set peptide sequence is one of those enumerated as the peptide sequences of data composing the individual hypotheses. The target property extraction section 162 extracts, out of the hypothetical data, the property specified by the peptide sequence set by the target sequence setting section 160. The variance evaluation section 164 calculates variances of the properties extracted by the target property extraction section 162, and thereby the data sets as previously shown in FIG. 4 are obtained. The obtained variances are sent to the question point extraction section 118.

The question point extraction section 118 fetches the variances obtained by hypothesis comparison section 114, in the decreasing order from the largest variance. FIG. 5 schematically shows a ranking among the data sets. Of these data sets, the data sets having variances within a seventh predetermined number of range, which is in a top-50 range herein, are extracted as the question point, and thus-extracted peptide sequences are sent to the data request section 120. It is also allowable that the peptide sequences having variances larger than a predetermined value are extracted as the peptide sequences as an object to which the true data is requested, that is, as the question point.

The data request section 120 requests the true data, which are for example experimentally measured data obtained by experiments or literature data accumulated in an external database or the like, with respect to the peptide sequences regarding the question point extracted by the question point extraction section 118, and the data acceptance section 122 accepts the measured data entered by the user, or literature data or the like obtained from a predetermined database as described later, in response to the request by the data request section 120, and sends these data, as the true data, to the data addition section 124.

In the data addition section 124, the true data sent from the data acceptance section 122 is once fetched in, correlated to the peptide sequence which remained as the question point, thereby the additional data sets containing the peptide sequences and the properties are generated, and the additional data are then sent to the data control section 128.

The sequence entry acceptance section 130 accepts entry of information on all amino acid sequences of a predetermined protein used for specifying peptide sequence candidates which are desired to be predicted, such as a target protein in need of identification of epitope, such as all amino acid sequences of a protein forming a viral antigen, and sends the accepted data to the sequence candidate extraction section 131. The entry may be made by using a predetermined input device through a user interface, or through a network by connecting the user interface to the network.

It is also allowable herein that any of the above-described target proteins other than the viral antigen may be an object for acceptance of sequence entry.

The sequence candidate extraction section 131 extracts the peptide sequence candidates to be predicted, based on all amino acid sequences of the predominant proteins, which is the information accepted by the sequence entry acceptance section 130, and the extracted peptide sequence candidates are sent to the individual learning sections 112.

The peptide sequences extracted by the sequence candidate extraction section 131 may sometimes contain sequences actually not usable. Such unnecessary sequence may automatically be excluded without human operation, by configuring the sequence candidate extraction section 131 as described in the above.

The property estimation section 132 estimates the properties of the individual peptide sequences, based on the peptide sequence candidates extracted by the sequence candidate extraction section 131 and excluded any unnecessary peptide sequences excluded therefrom as required, and based on the results obtained by the calculation in the estimation phase by the learning sections 112. The results of the calculation are obtained typically in a form of data sets as shown in FIG. 5 in the above, and the property estimation section 132 estimates, with respect to the individual peptide sequences by an average value for example as a binding constant of these peptide sequences to a predetermined protein, such as a target protein, wherein the estimation is made for all of the peptide sequence candidates, and the peptide sequences as combined with estimated properties are sent to the peptide database 138.

In the peptide database 138, the data sets composed of combinations of the properties estimated by the property estimation section 132, such as binding constant to HLA Class-A molecule, and the peptide sequences having these properties are obtained.

The condition entry acceptance section 134 accepts entry of a property which serves as a keyword for extracting the peptide sequences having a predetermined property from the peptide database 138, such as binding constant. The entry may be made by using a predetermined input device through a user interface, or through a network by connecting the user interface to the network as sequence entry acceptance section 130.

The entry accepted herein is a condition (property) requested depending on the peptide sequences to be extracted. For an exemplary case where the peptide sequence is used as a therapeutic drug for hepatitis C, the condition entry acceptance section 134 is configured so as to accept as keywords indicating a binding constant of 6 or above with respect to HLA Class-A molecule which is the predetermined protein.

The sequence extraction section 136 extracts the peptide sequences which satisfy the condition accepted by the condition entry acceptance section 134 from peptide database, and outputs thus-extracted peptide sequences as results of prediction.

For the case where it is desired to search, using a peptide sequence once predicted, property of a novel peptide sequence obtained by substituting one to several amino acids of this peptide sequence, the sequence entry acceptance section 130 may accept relevant entries such as the peptide sequences for which the binding constant is predicted, and such as an eighth predetermined number of information regarding how many amino acids in these peptide sequences will be substituted, then each of the learning sections 112 may execute calculation in the prediction phase, and thereby the property estimation section 132 can estimate the properties of the novel peptide based on results of the calculation.

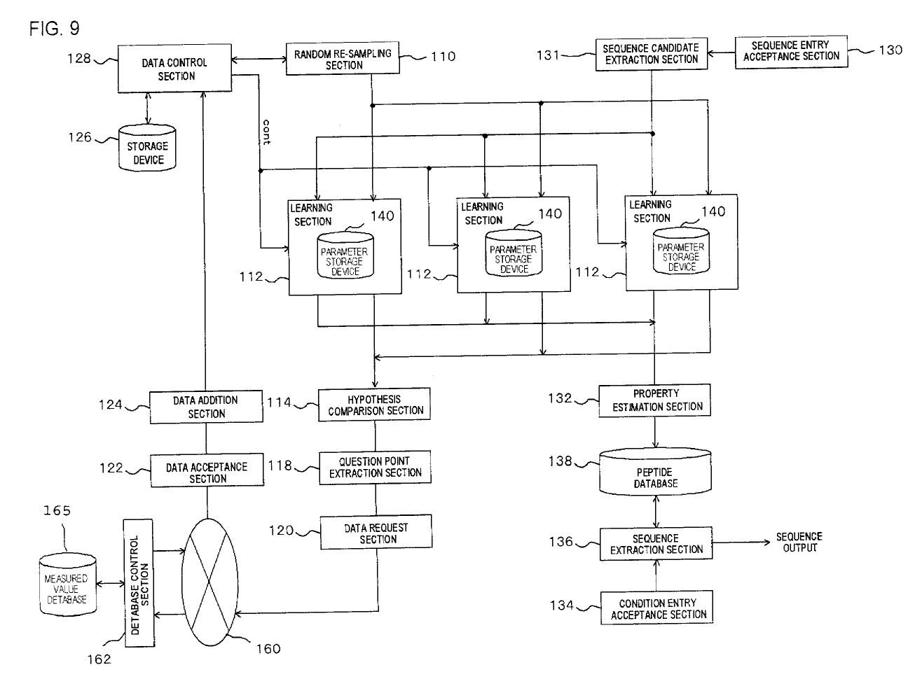

FIG. 9 is a diagram showing a case where the true data is requested to an external database, rather than to the user. Although the case applied to the sequence prediction system shown in FIG. 7 is shown herein, it is also allowable to apply it to the sequence prediction system shown in FIG. 1.

As shown in FIG. 9, the peptide sequences are sent through a network 160 to the database control section 162, upon being requested by the data request section 120, the database control section 162 searches measured values of the peptide sequences referring to a measured value database 164, and the obtained measured values are sent typically as the literature data through the network 160 to the data acceptance section 122. In this way, it is made possible to automatically obtain the true data, without human operation.

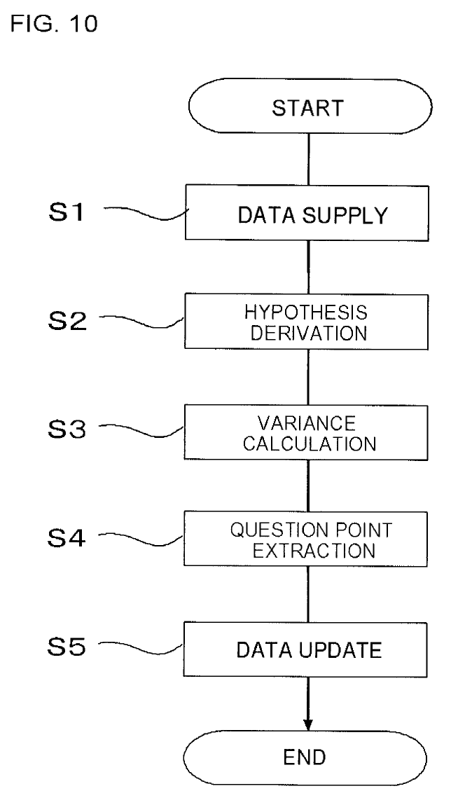

FIG. 10 is a flow chart explaining operations of the method of supporting sequence prediction according to the present invention. It is to be noted that the sequence prediction support system of this embodiment is included in the sequence prediction system according to the first embodiment shown in FIG. 1, so that the explanation below will be made occasionally referring to the reference numerals used in FIG. 1.

The method of supporting sequence prediction includes a data supply step, named step S1, selecting N data sets from a database having sequences of a biopolymer and add values owned by the biopolymer having the sequences, generating a different plurality of data subsets from the data sets, and supplying them to a learning section; a hypothesis derivation step, named step S2, generating in the learning section a hypothesis for each of the individual data subsets, applying the hypotheses respectively to the second data sets composed of biopolymer sequences independent of the data sets, to thereby derive add values of the biopolymer sequences relevant to the second data sets; a variance calculation step, named step S3, calculating variances of the add values of each of the biopolymer sequences in the second data sets; a question point extraction step, named step S4, extracting as question points biopolymer sequences having variances larger than a predetermined reference level among thus-calculated variances; and a data updating step, named step S5, accepting the add values corresponded to the question point, and accumulating thus-accepted add values in the database so as to correlate them with the biopolymer sequence relevant to the question point.

In step S1, N data sets composed of biopolymer sequences and the add values owned by the biopolymer having such sequences are selected by the data control section 128 from the storage device as the database, a different plurality of data subsets are generated from these N data sets, by the generation section 102, and are then supplied to the learning section 104.

In step S2, as described in the above, a hypothesis generated by the learning section 104 for each of the individual data subsets is applied to the biopolymer sequences (peptide sequences) of the second data sets, and thereby the add values of the individual peptide sequences are derived.

In step S3, as described in the above, variances of the add values of each of the biopolymer sequences are calculated by the question point extraction section 118. In step S4 in succession, the biopolymer sequences having variances larger than a predetermined reference level among thus-calculated variances are extracted as the question point, by the question point extraction section 118.

In step S5, the add values corresponded to thus-extracted question points are accepted by the data acceptance section 122, and thus-accepted add values are then sent by the data control section 128, to the storage device 126 and stored therein, as being correlated to the biopolymer sequences relevant to the question point, and thereby the contents of the storage device 126 are updated. In this way, the database supporting the sequence prediction can be constructed.

Although not shown in the drawing, it is also allowable to appropriately repeat steps S1 to S5, until a maximum value of variance obtained in step S3 falls smaller than a predetermined value, ensuring herein further improvement in reliability of contents of the sequence prediction support database.

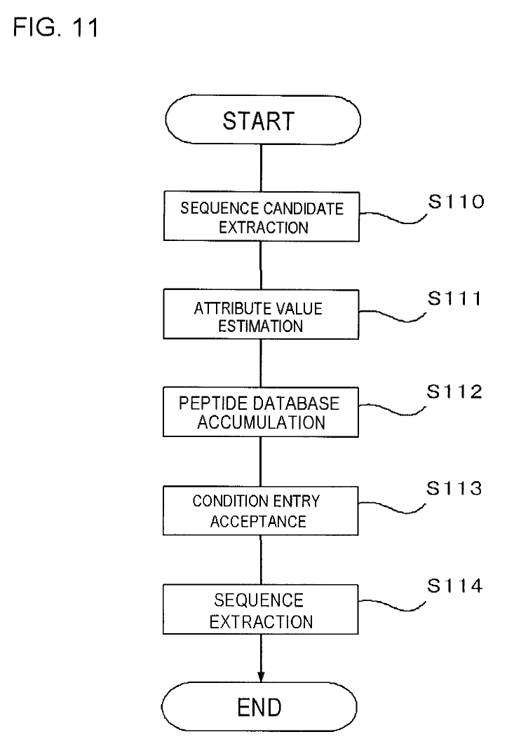

FIG. 11 is a flow chart showing operations of a sequence prediction system using the database constructed by the sequence prediction support system according to the first embodiment shown in FIG. 1, or using an available database.

In step S110 in FIG. 11, the sequence entry acceptance section 130 accepts all sequences of a predetermined biopolymer, such as a protein, and the sequence candidate extraction section 118 extracts, from thus-accepted all sequences, the biopolymer sequences to be predicted, which are peptide sequence candidates in this case, and then sends them to the learning section 104, In step S111, after acceptance of the sequence entry, the data control section 128 fetches all data sets in the storage device 128, and sends them to the learning section 104. In the learning section 104, a law is generated based on all data sets, then respectively applied to each of the biopolymer sequence candidates, and thereby the add values of the biopolymer sequence candidates are estimated.

In this way, it is made possible to estimate the add values with respect to a predetermined biopolymer sequence, based on the constructed database or an available database.

It is further made possible to construct the database of the data sets composed of the peptide sequences and the add values, by further providing step S112, to thereby send the add values estimated by the learning section 104 to the peptide database 138, and accumulate them as being correlated to the correspondent peptide sequences. The data sets are not limited to the peptide sequences, and instead any biopolymer sequences such as DNA, RNA and the like can be incorporated, together with the add values, into the database.

Step S113 and step S114 are further provided, wherein in step S113, the condition entry acceptance section 134 accepts entry of a keyword used for extracting the peptide sequences having predetermined add values from the peptide database 138, such as a condition expressing that the add value is larger than the binding constant with respect to a specific protein.

In step S114, the sequence extraction section 136 extracts the peptide sequences which satisfy the condition accepted by the condition entry acceptance section 134 from the peptide database 138, and outputs thus-extracted peptide sequences as the results of prediction.

In this way, the peptide sequences having the predetermined add values can be extracted as those expectedly indicative of an epitope capable of binding to the predetermined substance.

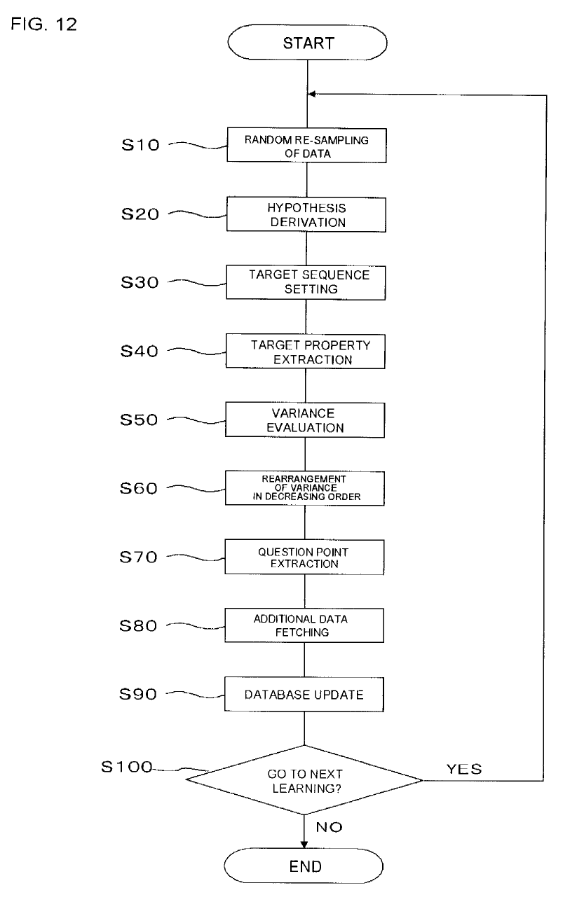

FIG. 12 is a flow chart explaining operations of the sequence prediction support system included in the sequence prediction system according to the second embodiment shown in FIG. 7. The explanation below will be made occasionally citing the reference numerals shown in FIG. 7.

In step S10, data are fetched from the storage device 126 by the data control section 128, and different data are randomly re-sampled through the random re-sampling 110 into the individual learning sections 112.

In step S20, the individual learning sections 112 analyze the supplied data, and derive the data sets containing scores determined for the third predetermined number of, herein 100,000, peptide sequences, based on a certain hypothesis, more specifically, peptide sequence and a predetermined property.

In step S30, the target sequence setting section 160 sets a predetermined peptide sequence used for comparison among the hypotheses derived by the individual learning sections 112. In step S40, the target property extraction section 162 extracts thus-set peptide sequence and the property from the hypothesis derived by the individual learning sections 112. In step S50, the variance evaluation section 164 evaluates variances in the properties extracted by the individual learning sections 112.

In step S60, the question point extraction section 118 fetches the peptide sequences in a decreasing order of variance evaluated by the variance evaluation section 164 in the hypothesis comparison section 114. The data sets thus obtained are schematically shown in FIG. 5.

In step S70, of the data sets obtained in step S60, those having the top-50 variances are extracted as the question point as described in the above, and thus-extracted peptide sequences are extracted as the peptide sequences as an object for which the true data is requested with respect to the properties of the hypotheses.

In step S80, the data request section 120 requests the true data, the data acceptance section 122 accepts thus-requested true data, and data addition section 124 defines the sequence extracted in step S70 with the true data obtained after acceptance of the property of the hypothesis, to thereby obtain the additional data.

In step S90, the additional data obtained by the data addition section 124 is sent through the data control section 128 to the storage device 126, and thereby the data of the storage device 126 is updated.

In step S100, whether the next learning is executed or not is discriminated. If the result of discrimination is YES, that is indicating execution of the next learning, the process returns back to step S10, and the random re-sampling 110 randomly supplies data for the learning to the individual learning sections 112. If the result of discrimination is NO, that is indicating no execution of the next learning, the sequence prediction support operation ends.

The number of times of learning herein may preliminarily be determined to as large as a predetermined value, or may be judged every time the learning ends.

In this way, the database supporting sequence prediction is constructed.

It is also allowable in steps S60 and S70 to extract the peptide sequences having the evaluated variances of a predetermined value or larger as the question point, in place of extracting the peptide sequences after rearranging them in a decreasing order of variance of the hypothetical data, and extracting those having variances within a predetermined range, for example in the top-50 range as the question point.

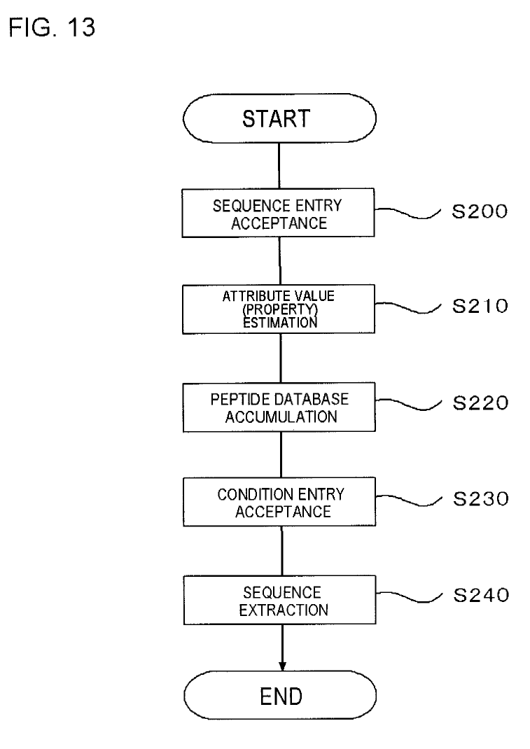

FIG. 13 is a flow chart showing operations of the sequence prediction system using the database constructed by the sequence prediction support system according to the second embodiment.

In step S200, the sequence entry acceptance section 130 accepts all amino acid sequences of a viral antigen which is a target protein of a predetermined substance, such as antigen-presenting molecule, and in step S210, the peptide sequence candidates to be predicted are extracted from thus-accepted all amino acid sequences, and then subjected to calculation by the learning section 112 in the estimation phase, and based on the results of calculation, the property estimation section estimates binding constant with the viral antigen as the peptide sequence candidates, and in step S220, the data sets containing all these peptide sequence candidates and the predetermined property are generated and accumulated in the peptide database 138.

In step S230, the condition entry acceptance section 134 accepts entry of the property which serves as a keyword for extracting, from the peptide database 138, the peptide sequences having a predetermined property, such as binding constant with a determined protein.

In step S240, the sequence extraction section 136 extracts, from the peptide database 138, the peptide sequences which satisfy the condition accepted by the condition entry acceptance section 134, and outputs the extracted peptide sequences as the results of prediction.

In this way, the peptide sequences having the predetermined property can be extracted as those expectedly indicative of an epitope capable of binding to the predetermined substance.

calculation for prediction of epitope can be realized herein, by allowing the learning section 104 to output, as the hypotheses, a list of 9 amino acids derived from an amino acid sequence of another predetermined protein, such as a target protein, such as a viral antigen, in place of the third predetermined number of peptide sequences and corresponded values of the binding constant, and the third predetermined number is not limited to 100,000, whereas it is also allowable to predict all combinations of the peptide sequences by allowing the learning section 115 to output all combinations of the peptide sequences which totals 20⁹ if the fifth predetermined number is set as 9.

This embodiment has been explained referring to an example of predicting a peptide sequence composing a epitope of a specific target protein, whereas it is also allowable to predict, as a property initially entered to the learning sections 112, a peptide sequence having an immunity inducing ability, as an index expressing immunity induction ability, such as bioactivity expressed by the number of proliferation of T-cell induced by binding to the target.

For the purpose of predicting an assay system aimed at optimizing ligands of an orphan G-protein coupled receptor (orphan GPCR) for which a peptide may supposedly be involved as a ligand but not yet specifically identified, and more specifically for the purpose of obtaining an index numerically expressing bioactivity such as increase in calcium level or intracellular cAMP (intracellular biological molecule) in cultured cells in conjunction with peptide dose, it is also allowable to predict a peptide sequence optimal to the assay system.

Also the peptide sequence can be predicted, making use of increase in the blood level of a bioactive peptide or a bioactive hormone composed of the peptide, as an index of the bioactivity.

This embodiment is adoptable to prediction of DNA sequence. For example, expression of a gene needs binding of a transcription factor controlling gene expression on the upstream of the gene sequence on the DNA, and the DNA base sequence forming the binding site of the transcription factor is known to have a certain motif or law. Prediction of a sequence candidate of a transcription factor bindable to a promoter relevant to a specific gene expression, therefore, makes it possible to find a law between gene expression and DNA sequence pattern of the transcription factor binding site in a specific gene expression system, and thereby control of the gene expression and binding of the transcription factor becomes available.

This embodiment is adoptable also to prediction of RNAi sequence. For example, an PNA base sequence (siRNA) having 10 to 20 specific bases, which is a double-strand small molecule, is known to bind with a mRNA having a sequence homology under the presence of a cofactor and to scissor it, thereby interfering production of gene products, on the upstream and downstream sides. Prediction of sequence candidates of an siRNA bindable to a mRNA related to a specific gene expression, therefore, makes it possible to predict interrelation between a specific biological activity and an RNAi sequence, and also to design a sequence of RNAi which has extensively been investigated and developed in recent years as a drug candidate substance.

This embodiment is adoptable still also to prediction of RNA aptamer sequence. The RNA aptamer is generally an RNA chain having 20 or more bases, has a stable stereo structure by forming bonds between complementary bases within the sequence, and binds to a specific functional site of a target protein or the like making use of this structural feature to thereby control the function thereof. Prediction of candidates of an RNA base sequence having a structure bindable to a functional site of a target protein, therefore, makes it possible to predict interrelation between a specific biological activity and the RNA aptamer sequence, and also to design a sequence of RNA aptamer which has extensively been investigated and developed in recent years as a drug candidate substance.

The present invention also provides a program allowing a general-purpose computer device to function as the above-described sequence prediction system or the sequence prediction support system.

As has been described in the above, according to this embodiment, it is made possible to select only biopolymer sequences having a predetermined property, such as peptide sequence or base sequence of nucleic acid, without relying upon experiments.

Operations of each configuration of the above-described sequence prediction system or the sequence prediction support system can also be expressed by a program, and use of this sort of program allows a general-purpose computer to operate as the above-described sequence prediction system or the sequence prediction support system.

In order to exclude unnecessary peptide sequences from the candidates calculated in the next learning stage in the learning sections 112, the question point extraction section 118 may be provided with an unnecessary sequence exclusion section and, if necessary, an unnecessary sequence database typically as shown in FIG. 7. By adopting this configuration, it is made no more necessary to request the true data with respect to the unnecessary peptide sequences.

1. A sequence prediction system comprising:
a database having biopolymer attributes which contain sequences of a biopolymer, and add values owned by said biopolymer having said sequences;
a selection section selecting N data sets from said database;
a generation section generating a different plurality of data subsets from said data sets;
a learning section generating a hypothesis for each of the individual data subsets, applying said hypotheses respectively to second data sets composed of biopolymer sequences independent of said data sets, to thereby derive add values of said biopolymer sequences relevant to said second data sets;
a question point extraction section finding variances of the add values for the individual biopolymer sequences in said second data sets, and extracting, as question points, biopolymer sequences having variances larger than a predetermined reference level;
a data control section accepting the add values corresponded to said question point, and accumulating the accepted add values in said database so as to correlate them with said biopolymer sequences relevant to said question point;
a sequence entry acceptance section accepting all sequences of a predetermined biopolymer;
a sequence candidate extraction section extracting biopolymer sequence candidates to be predicted, from all sequences accepted by said sequence entry acceptance section; and
an add value estimation section generating, after entry and acceptance of the sequences, a law based on all data sets of said database, and applying said law respectively to said biopolymer sequence candidates, to thereby estimate add values of said biopolymer sequence candidates.

2. The sequence prediction system as claimed in claim 1, wherein said learning section functions as a add value estimation section after acceptance of sequence entry.

3. The sequence prediction system as claimed in claim 1, wherein said sequence candidate extraction section extracts a biopolymer sequence by “p” monomer fetched units at a time from the head of all sequences accepted by said sequence entry acceptance section, and then extracts the succeeding biopolymer sequence candidates by “p” monomer fetched units, at intervals of “q” monomer units, shifted towards the downstream side.

4. The sequence prediction system as claimed in claim 1, wherein said sequence candidate extraction section excludes, from the extracted biopolymer sequence candidates, any biopolymer sequences which satisfy a predetermined condition in no need of prediction, before being sent to said add value estimation section.

5. The sequence prediction system as claimed in claim 1, wherein said question point extraction section extracts, as the question point, the biopolymer sequences having variances within a predetermined range away from the largest variance.

6. The sequence prediction system as claimed in claim 1, wherein said question point extraction section extracts, as the question point, the biopolymer sequences having variances larger than a predetermined value.

7. The sequence prediction system as claimed in claim 1, further comprising a sequence extraction section extracting biopolymer sequence candidates having said add value which satisfies a predetermined condition, from the add values of the individual biopolymer sequence candidates estimated by said add value estimation section.

8. The sequence prediction system as claimed in claim 1, said biopolymer sequence is either of amino acid sequence of peptide, or base sequence of nucleic acid.

9. The sequence prediction system as claimed in claim 8, wherein said add value is binding constant of peptide or nucleic acid with respect to a predetermined biopolymer.

10. A sequence prediction system comprising:
a database having biopolymer attributes which contain sequences of a biopolymer, and add values owned by said biopolymer having said sequences;
a sequence entry acceptance section accepting all sequences of a predetermined biopolymer;
a sequence candidate extraction section extracting biopolymer sequence candidates to be predicted, from all sequences accepted by said sequence entry acceptance section; and
an add value estimation section generating, after acceptance of the sequences, a law based on all data sets of said database, and applying said law respectively to said biopolymer sequence candidates, to thereby estimate add values of said biopolymer sequence candidates.

11. A sequence prediction database containing the add values obtained by the sequence prediction system described in claim 1, and a biopolymer sequence.

12. A sequence prediction support system comprising:
a database having biopolymer attributes which contain sequences of a biopolymer, and add values owned by said biopolymer having said sequences;
a selection section selecting N data sets from said database;
a generation section generating a different plurality of data subsets from said data sets;
a learning section generating a hypothesis for each of the individual data subsets, applying said hypotheses respectively to second data sets composed of biopolymer sequences independent of said data sets, to thereby derive add values of said biopolymer sequences relevant to said second data sets;
a question point extraction section finding variances of the add values for the individual biopolymer sequences in said second data sets, and extracting, as question points, biopolymer sequences having variances larger than a predetermined reference level; and
a data control section accepting the add values corresponded to said question point, and accumulating the accepted add values in said database so as to correlate them with said biopolymer sequences relevant to said question point.

13. A sequence prediction support system comprising:
a database having biopolymer attributes which contain sequences of a biopolymer, and an add value owned by said biopolymer having said sequence;
a selection section selecting N data sets from said database;
a generation section generating a different plurality of data subsets from said data sets; and
a learning section generating a hypothesis for each of the individual data subsets, applying said hypotheses respectively to the second data sets composed of biopolymer sequences independent of said data sets, to thereby derive add values of said biopolymer sequences relevant to said second data sets.

14. A sequence prediction system comprising:
a database having stored therein data containing peptide sequences each composed of a first predetermined number of amino acids, and a property providing an index of a predetermined biological activity of said peptide sequence;
a plurality of learning sections deriving hypotheses for a third predetermined number of peptide sequences from said peptide sequences and said property, based on a second predetermined number of said data;
a random re-sampling section fetching a fourth predetermined number of data from said database, and randomly supplying them to each of said learning sections by said second predetermined number of data;
a target sequence setting section setting a predetermined peptide sequence contained in said hypotheses derived by said individual learning sections;
a target property extraction section extracting, from said hypotheses derived by each of said learning sections, the property specified by thus-set predetermined peptide sequences respectively;
a variance evaluation section evaluating variances of said property extracted from each of said learning sections;
a question point extraction section extracting a peptide sequence as an object to which a true data for the property of said hypothesis is requested, based on thus-evaluated variance;
a data updating section accepting said requested true data, and correlating said extracted peptide sequence with said property based on said true data;
a data control section accumulating a new data obtained by said data updating section as containing said peptide sequence and the property based on said true data, into said database;
a sequence entry acceptance section accepting all amino acid sequences of a predetermined protein;
a sequence candidate extraction section extracting peptide sequence candidates to be predicted, from all amino acid sequences accepted by said sequence entry acceptance section, and sending thus-extracted peptide sequence candidates to said learning sections; and
a property estimation section estimating the property of said extracted peptide sequence candidates, based on results obtained from each of said learning sections.

15. A sequence prediction system comprising:
a database having stored therein data containing peptide sequences each composed of a first predetermined number of amino acids, and the property providing an index of a predetermined biological activity of said peptide sequences;
a plurality of hypothesis derivation section randomly fetching a fourth predetermined number of data from said database, and deriving hypotheses for a third predetermined number of peptide sequences from said peptide sequences and said property, based on a second predetermined number of said data randomly sent out of said fourth predetermined number of data;
a question point sequence extraction section setting predetermined peptide sequences contained in said hypotheses derived by each of said hypothesis derivation sections, extracting the property specified by thus-set predetermined peptide sequences respectively from said hypotheses derived by each of said hypothesis derivation sections, evaluating variance of thus-extracted the property, and extracting a peptide sequence to which a true data for the property of said hypothesis is requested, based on thus-evaluated variance;
a data updating section accepting said requested true data, and correlating said extracted peptide sequence with said property based on said true data;
a data control section accumulating a new data obtained by said data updating section as containing said peptide sequence and the property based on said true data, into said database; and
a property estimation/output section accepting all amino acid sequences of a predetermined protein, extracting peptide sequence candidates to be predicted, from thus-accepted all amino acid sequence, sending thus-extracted peptide sequence candidates to said hypothesis derivation section, and estimating the property of thus-extracted peptide sequence candidates based on the output results.

16. A sequence prediction program allowing a computer to function as a sequence prediction system which comprises:
a database having biopolymer attributes which contain sequences of a biopolymer, and add values owned by said biopolymer having said sequences;
a selection section selecting N data sets from said database;
a generation section generating a different plurality of data subsets from said data sets;
a learning section generating a hypothesis for each of the individual data subsets, applying said hypotheses respectively to second data sets composed of biopolymer sequences independent of said data sets, to thereby derive add values of said biopolymer sequences relevant to said second data sets;
a question point extraction section finding variances of the add values for the individual biopolymer sequences in said second data sets, and extracting, as question points, biopolymer sequences having variances larger than a predetermined reference level;
a data control section accepting the add values corresponded to said question point, and accumulating the accepted add values in said database so as to correlate them with said biopolymer sequences relevant to said question point;
a sequence entry acceptance section accepting all sequences of a predetermined biopolymer;
a sequence candidate extraction section extracting biopolymer sequence candidates to be predicted, from all sequences accepted by said sequence entry acceptance section; and
an add value estimation section generating, after entry and acceptance of the sequences, a law based on all data sets of said database, and applying said law respectively to said biopolymer sequence candidates, to thereby estimate add values of said biopolymer sequence candidates.

17. A sequence prediction program allowing a computer to function as a sequence prediction system which comprises:
a database having biopolymer attributes which contain sequences of a biopolymer, and add values owned by said biopolymer having said sequences;
a sequence entry acceptance section accepting all sequences of a predetermined biopolymer;
a sequence candidate extraction section extracting biopolymer sequence candidates to be predicted, from all sequences accepted by said sequence entry acceptance section; and
an add value estimation section generating, after acceptance of sequence entry, a law based on all data sets of said database, and applying said law respectively to said biopolymer sequence candidates, to thereby estimate add values of said biopolymer sequence candidates.

18. A sequence prediction support program allowing a computer to function as a sequence prediction system which comprises:
a database having biopolymer attributes which contain sequences of a biopolymer, and add values owned by said biopolymer having said sequences;
a selection section selecting N data sets from said database;
a generation section generating a different plurality of data subsets from said data sets;
a learning section generating a hypothesis for each of the individual data subsets, applying said hypotheses respectively to second data sets composed of biopolymer sequences independent of said data sets, to thereby derive add values of said biopolymer sequences relevant to said second data sets;
a question point extraction section finding variances of the add values for the individual biopolymer sequences in said second data sets, and extracting, as question points, biopolymer sequences having variances larger than a predetermined reference level; and
a data control section accepting the add values corresponded to said question point, and accumulating the accepted add values in said database so as to correlate them with said biopolymer sequences relevant to said question point.

19. A method of sequence prediction comprising:
a data supply step selecting N data sets from a database having sequences of a biopolymer and add values owned by said biopolymer having said sequences, generating a different plurality of data subsets from said data sets, and supplying them to a learning section;
a hypothesis derivation step generating, in said learning section, a hypothesis for each of the individual data subsets, applying said hypotheses respectively to second data sets composed of biopolymer sequences independent of said data sets, to thereby derive add values of said biopolymer sequences relevant to said second data sets;
a variance calculation step calculating variances of the add values of each of said biopolymer sequences in said second data sets;
a question point extraction step extracting, as question points, biopolymer sequences having variances larger than a predetermined reference level among thus-calculated variances;
a data updating step accepting the add values corresponded to said question point, and accumulating thus-accepted add values in said database so as to correlate them with said biopolymer sequences relevant to said question point;
a sequence candidate extraction step accepting all sequences of a predetermined biopolymer, and extracting biopolymer sequence candidates to be predicted, from thus-accepted all sequences; and
an add value estimation step generating, after acceptance of entry of the sequences, a law based on all data sets of said database, and applying said law respectively to said biopolymer sequence candidates, to thereby estimate add values of said biopolymer sequence candidates.

20. A method of supporting sequence prediction comprising:
a data supply step selecting N data sets from a database having biopolymer attributes which contain sequences of a biopolymer, and add values owned by said biopolymer having said sequences, generating a different plurality of data subsets from said data sets, and supplying them to a learning section;
a hypothesis derivation step generating, in said learning section, a hypothesis for each of the individual data subsets, applying said hypotheses respectively to second data sets composed of biopolymer sequences independent of said data sets, to thereby derive add values of said biopolymer sequences relevant to said second data sets;
a variance calculation step calculating variances of the add values of each of said biopolymer sequences in said second data sets;
a question point extraction step extracting, as question points, biopolymer sequences having variances larger than a predetermined reference level among thus-calculated variances; and
a data updating step accepting the add values corresponded to said question point, and accumulating thus-accepted add values in said database so as to correlate them with said biopolymer sequences relevant to said question point.
